(19) United States
(12) Patent Application Publication
(10) Pub. No.: US 2005/0287503 A1
(43) Pub. Date: Dec. 29, 2005

(54) System of teaching success and method thereof

(76) Inventor: Kevin W. George, East Schodack, NY (US)

Correspondence Address: ARLEN L. OLSEN;SCHMEISER, OLSEN & WATTS, 3 LEAR JET LANE, SUITE 201, LATHAM, NY, 12110, US

(21) Appl. No.: 10/878,827

(22) Filed: Jun. 28, 2004

(51) Int. Cl. G09B 19/00

(52) U.S. Cl. 434/236

(57) ABSTRACT

A method for teaching success to a student and a storage device incorporating computer instructions for teaching the method. The method including: instructing the student to identify a personal goal; instructing the student to identify a set of possible or potential activities to achieve the personal goal; teaching the student to distinguish each activity of the set of possible or potential activities between new brain activity and an old brain activity, the new brain activity promoting achieving the personal goal and the old brain activity impeding achieving the goal; and instructing the student to implement at least one activity of the of activities identified as new brain activities in order to achieve the personal goal.

### FIELD OF THE INVENTION

The present invention relates to the field of teaching; more specifically, it relates to system and method for teaching success.

### BACKGROUND OF THE INVENTION

A portion of the disclosure of the present invention contains material that is subject to copyright protection. The copyright owner has no objection to the facsimile reproduction by anyone of the patent document or patent disclosure, as it appears in the Patent and Trademark Office patent files or records, but otherwise reserves all copyrights whatsoever.

Success may be defined as the achievement of something desired, planned, or attempted. However, in some cases, success may not be achieved. Therefore, there is a need for a system and method for teaching success.

### SUMMARY OF THE INVENTION

A first aspect of the present invention is a method for teaching success to a student, comprising: a. instructing said student to identify a compelling desire or personal goal of said student; b. instructing said student to list possible or potential old brain activities that result in SLOW CA•rs and possible or potential new brain activities that result in FAST CA•rs; c. instructing said student to select and implement at least one of the possible or potential new brain activities associated with the FAST CA•rs; d. instructing said student to utilize a success roadmap to achieve the FAST CA•rs in order to achieve said compelling desire or personal goal; e. instructing said student to ask whether said compelling desire or personal goal of said student has been achieved; and f. instructing said student to repeat steps b to e if the compelling desire or personal goal has not been achieved, or to exit the method.

A second aspect of the present invention is a method for teaching success to a student, comprising: a. instructing said student to identify a compelling desire or personal goal of said student; b. recording said compelling desire or personal goal of said student; c. instructing said student to list possible or potential old brain activities that result in SLOW CA•rs and possible or potential new brain activities that result in FAST CA•rs; d. instructing said student how to select and implement at least one of the possible or potential new brain activities associated with the FAST CA•rs; e. instructing said student to how to utilize a success roadmap to achieve the FAST CA•rs in order to achieve said compelling desire or personal goal; f. instructing said student to ask whether said compelling desire or personal goal of said student has been achieved; and g. instructing said student to repeat steps b to f if the compelling desire or personal goal has not been achieved, or to exit the method.

A third aspect of the present invention a program storage device readable by a machine, tangibly embodying a program of instructions executable by said machine to perform method steps for a method for teaching success to a student said method steps comprising: instructing said student to identify a compelling desire or a personal goal; instructing said student to identify a set of possible or potential activities to achieve said compelling desire or personal goal; teaching said student to distinguish each activity of said set of possible or potential activities between new brain activity and an old brain activity, said new brain activity promoting achieving said personal goal and said old brain activity impeding achieving the goal; and instructing said student to implement at least one activity of said of activities identified as new brain activities in order to achieve said personal goal.

A fourth aspect of the present invention is a program storage device readable by a machine, tangibly embodying a program of instructions executable by said machine to perform method steps for a method for teaching success to a student, said method steps comprising: instructing said student to identify a personal goal; recording said personal goal; teaching said student to identify a set of possible or potential activities to achieve said personal goal; recording said set of possible or potential activities; teaching said student how to distinguish each activity of said set of possible or potential activities between new brain activity and an old brain activity, said new brain activity promoting achieving said personal goal and said old brain activity impeding achieving the goal; instructing said student to determine for each activity of said set of possible or potential activities if each activity is a new brain activity or an old brain activity recording said determinations for each activity; instructing said student to implement at least one activity of said of activities identified as new brain activities in order to achieve said personal goal.

### BRIEF DESCRIPTION OF DRAWINGS

The features of the invention are set forth in the appended claims. The invention itself, however, will be best understood by reference to the following detailed description of an illustrative embodiment when read in conjunction with the accompanying drawings, wherein:

FIG. 1A is an overall flowchart of a method for teaching success according to the present invention;

FIG. 1B depicts at least one Success CA•rs creative energy distribution, according to embodiments of the present invention;

FIG. 1C depicts FIG. 1A after students redistribute and re-balance their creative energy to allocate more creative energy to power or achieve their Creative Ambitions or Creative Actions or sustained right actions and their Success-Creative Activities, according to embodiments of the present invention;

FIG. 1D depicts a Success CA•rs dwelling time redistribution, according to embodiments of the present invention;

FIG. 1E depicts a Success Roadmap, according to embodiments of the present invention;

FIG. 1F depicts a Success CA•rs creative energy redistribution, according to embodiments of the present invention;

FIG. 1G depicts Self-governance of the Ideal Self, according to embodiments of the present invention;

FIG. 1H depicts a method for using techniques to overcome the stop reflex, according to embodiments of the present invention;

FIG. 1I depicts the students' creative energy, such as their perceived pleasure versus time that may power students' Creative Ambitions, according to the present invention.

FIG. 2 is a crisis of need or relevance diagram, according to the present invention;

FIG. 3 is a pictorial representation illustrating a worksheet for inputting information, according to the present invention;

FIG. 4 is a detailed flowchart for teaching the five keys to success, according to the present invention;

FIG. 5 is a schematic block diagram of a general-purpose computer that may be used for practicing the present invention; and

FIG. 6 is a pictorial representation illustrating a Success Roadmap, according to the present invention.

### DETAILED DESCRIPTION OF THE INVENTION

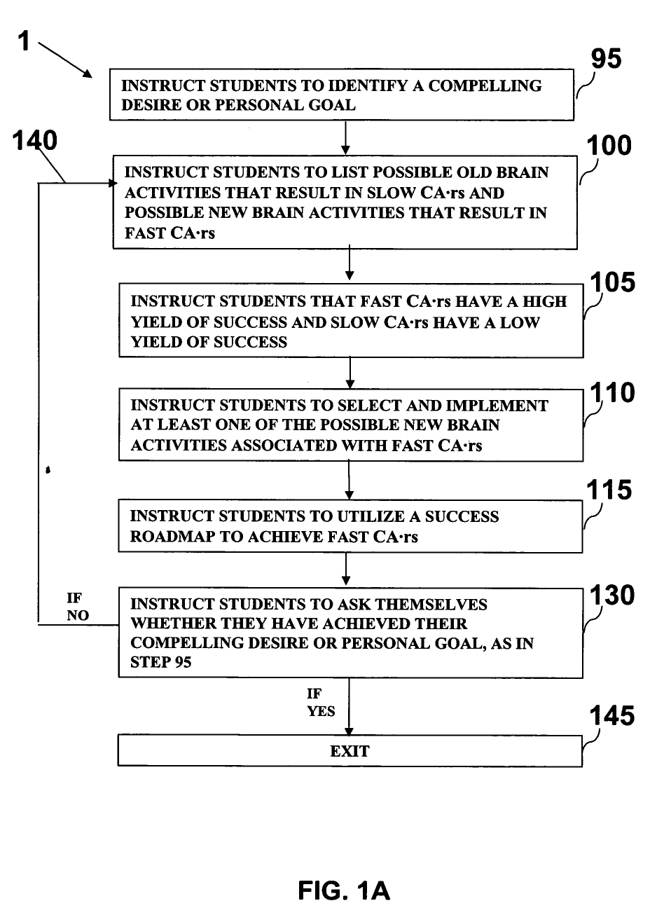

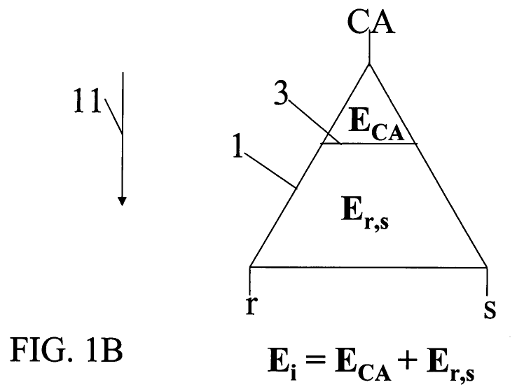

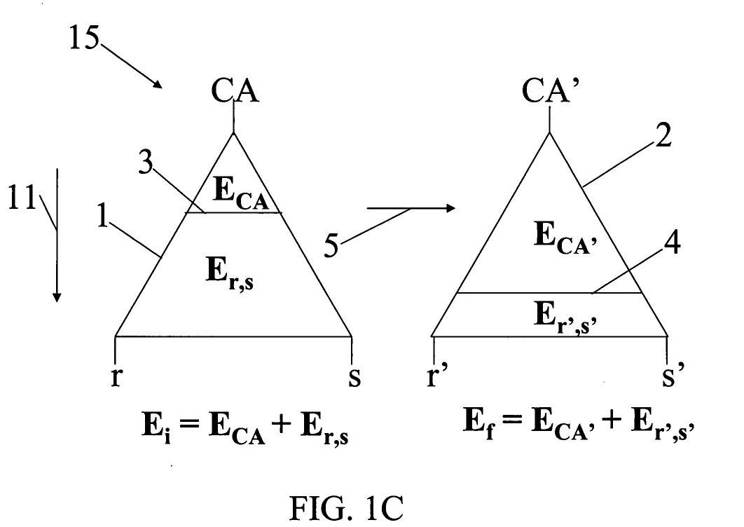

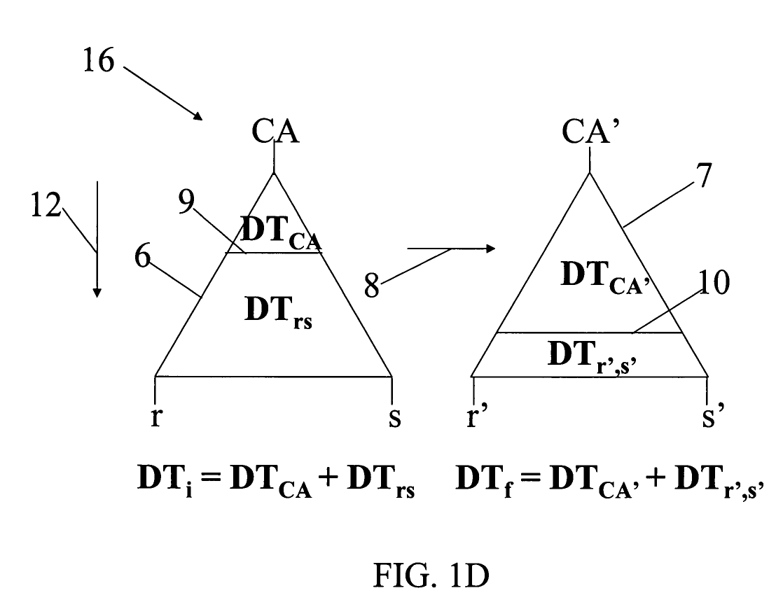

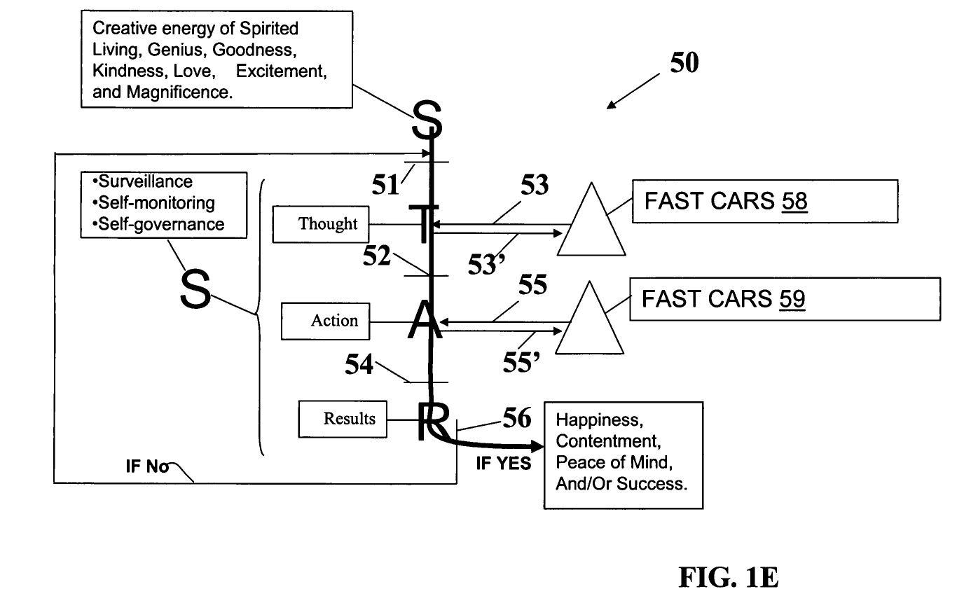

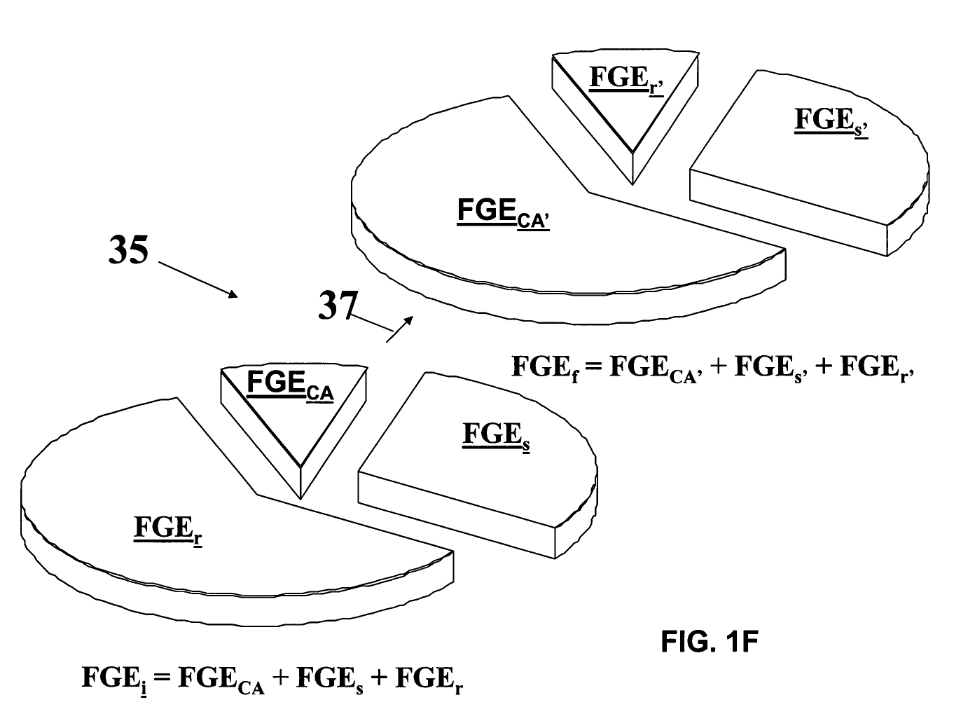

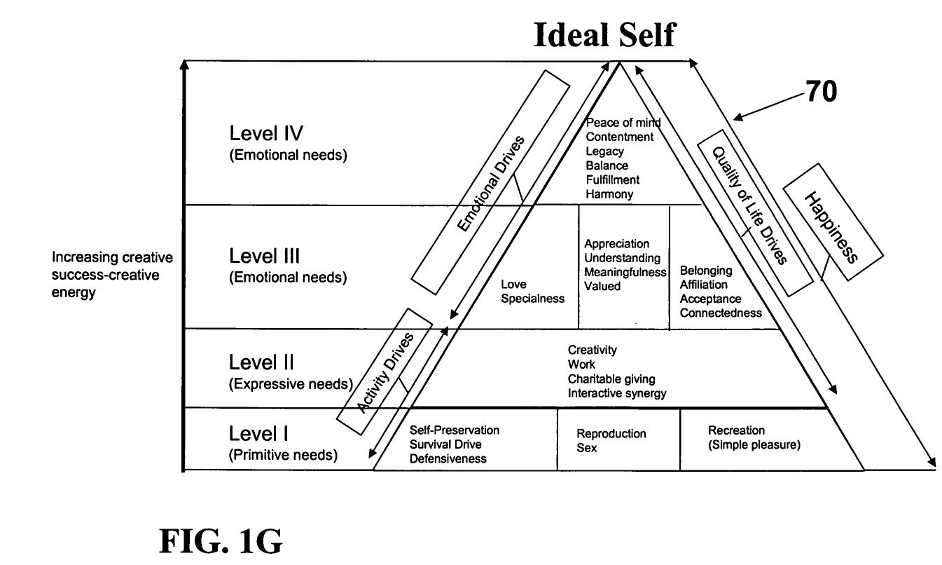

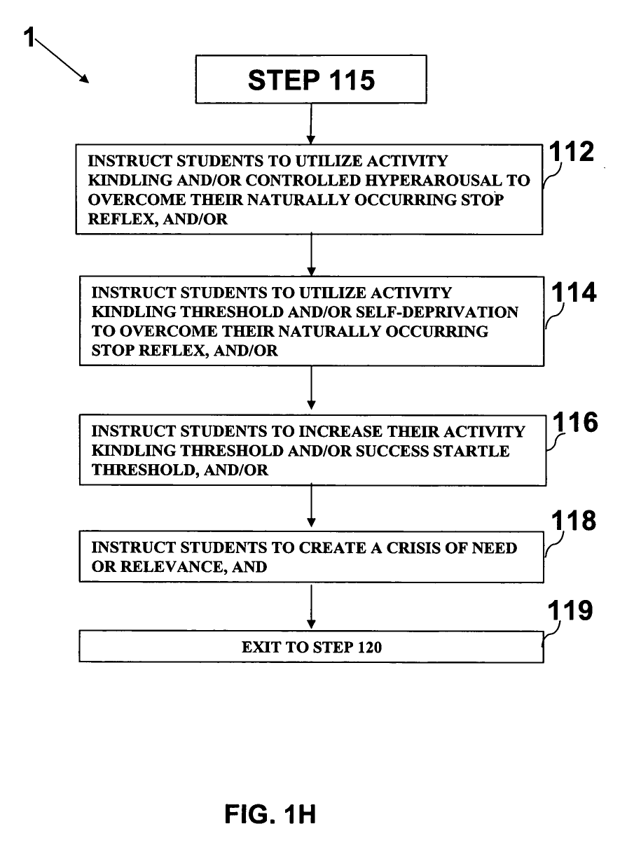

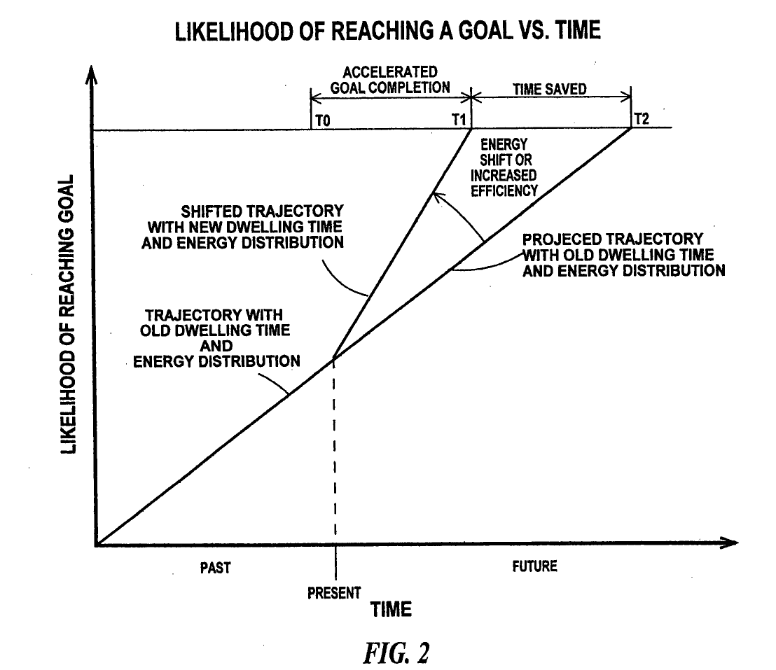

FIG. 1A is an overall flowchart of a method 1 for teaching success, according to the present invention. In step 95, success, self-empowerment and self-governance are defined for the students and the students are instructed to select a personal goal that may be far beyond their comfort limit. Success may be defined as the degree of efficiency in materializing thought through self-governance. “Self-governance” may be defined as the degree of efficiency in controlling ones's activity drives, emotional drives and quality of life drives or instincts, as depicted in FIG. 1G, infra, and described herein, such that one, such as students of the systems and methods of teaching success of the present invention may be in a happy state of mind, wherein “happy” may be defined as enjoying, showing, or marked by pleasure, satisfaction, or joy.

Alternatively, success may be defined as the achievement of something desired, planned, or attempted, such as, for example, happiness or legacy. “Legacy” is one's heritage that may be handed down from an ancestor or a predecessor or from the past. Alternatively, success means applied creativity. Success is an action that accomplishes its intended purpose. Success is achieved by selling yourself on doing all the things you hate to do because you appreciate the importance of overriding your natural internal auto-resistance to change and your default tendency to avoid unpleasant obstacles.

The opposite of success is failure. Failure is performing and achieving far below your true possible or potential and abilities. Failure is your inability each day to resume and maintain the integrity of your focus, attention, interest, and pleasure in pursuing your desired goals.

Success may also be that which comes after; hence, consequence, issue, or result, of an endeavor or undertaking, whether good or bad; the outcome of effort. Success may be the favorable or prosperous termination of anything attempted; the attainment of a proposed object, prosperous issue. Empower may have the legalistic meaning “to invest with authority, authorize.” It may be used with an infinitive in a more general way meaning “to enable or permit.” Self-empowerment may be defined as a system of managing your life such that you increase your probability of taking consistent creative actions or sustained right actions, which in turn, increases your probability of achieving great success. Self-empowerment puts you on the fast track to unlimited success:
Puts you in control of your life and your interactions or sustained right actions with those around you
Teaches you how to regain your creativity and creative edge
Teaches you how to promote and sustain your creative drive

Examples of personal goals include, but are not limited to: balancing ones time between family, work and personal; achieving harmony between ones personal values and beliefs and those of society; achieving happiness; achieving contentment; achieving specialness; achieving peace of mind; increasing interaction with others; increasing level of giving of ones talent; solving large scale problems; increasing altruism; increasing ones level of service to humanity; increasing ones level of community service; matching ones level of accomplishment in life to ones true possible or potential, by application of ones own creativity, genius and magnificence; achieving personal and emotional growth; upholding happiness as a central focus in life; promotion and advancement of individual success; nurturing a team spirit; creating an atmosphere of increased positive creative energy to buffer against the prevailing culture of negativity, fear and misery. Hereinafter, “creative energy” is having the ability or power to create, e.g., having the ability or power to be productive, ability or power characterized by originality and expressiveness, imaginativeness, e.g., having the ability or power to write creatively. “Creative energy” may also be the ability or power of one who displays productive originality, e.g., the creatives in the advertising department.

FIG. 1B depicts at least one Success CA•rs 1, comprising any plane or solid geometric figure such as a circle, square, rectangle, or a sphere, cube, parallelepiped and the like. The at least one Success CA•rs 1 comprises: a student's new brain Creative Ambitions and/or Creative Actions or sustained right actions, hereinafter abbreviated as upper case CA, old brain survival or self-protection drives or instincts, hereinafter abbreviated as lower case s, and old brain recreation drives or instincts, or overindulgence in recreation, such as for instant gratification, hereinafter abbreviated as lower case r. The term Creative Ambitions and/or Creative Actions or sustained right actions, CA, may be an eager or strong desire to achieve something characterized by originality and expressiveness. Alternatively, Creative Ambitions and/or Creative Actions or sustained right actions, CA, may be imaginative or a desire for exertion or activity characterized by originality and expressiveness. The term recreation, r, may be a drive or instinct for refreshment of one's mind or body after work through activity that amuses or stimulates; play. The term recreation, r, may be a drive or instinct for instant gratification. The term recreation may also be indulgence in play or in simple pleasures. The term “recreation” does not mean “creation again,” as in “re-create,” in the context of embodiments of the present invention. The term “recreation” means a diversion. Recreation may also mean refreshment of one's strength and spirits after toil; amusement; diversion; sport; pastime. The term survival, s, may be a drive or instinct for protection of oneself from harm or destruction, and the drive or instinct for individual preservation; the innate desire to stay alive. Alternatively, the term survival, s, may be a drive or instinct for preservation of oneself from harm; a natural or instinctive tendency towards self-preservation or survival.

Old brain recreation, r drives or instincts for instant gratification may arise from witnessing startlingly sudden tragedy such as loss of life or property on a massive scale that results in people being less willing to rely on planning, anticipating, and developing long-term goals. Alternatively, old brain recreation drives or instincts for instant gratification may arise in people who no longer believe in the virtue of patience and simply want instant gratification. Hereinafter, “instant gratification” means behavior of a student in which the student prefers receiving a small reward at this instant, rather than receiving a larger reward in the future. Such people may be characterized as impulsive and as lacking in the ability to defer or delay gratification, i.e., as having medical conditions such as attention deficit/hyperactivity disorder (ADHD), bipolar disorder, frontal lobe disorder, and drug addiction. Lesions in an area of the forebrain involved in reward, the nucleus accumbens core (AcbC), may cause the student to simply want instant gratification, e.g., always chosing a more immediate, smaller reward over a bigger, later one. The finding suggests that damage to this brain area could contribute to behavioral disorders characterized by the urge for instant gratification or being impulsive. Drugs such as amphetamine and cocaine may act on the AcbC, altering levels of the neurotransmitter dopamine. The student may be taught the drug Ritalin, the controversial drug widely used to control hyperactive and inattentive children, may also act on the AcbC, altering levels of the neurotransmitter dopamine and/or adrenalin. Hereinafter, behavior characterized by the desire for instant gratification, hyperactivity, and/or inattentiveness may result from an unhealthy low level of dopamine, that may be due to an unhealthy AcbC. Alternatively, old brain survival or self-protection instincts may arise from other reward-related areas of the brain, such as the amygdala, which is involved in fear.

It has been found that dopamine produces a feeling of well-being, happiness, altruism and general self-satisfaction, and that increasing its level may result in offsetting or countering the bad effects of an unhealthy level of adrenalin, such as hyperactivity and inattentiveness. In embodiments of the present invention, students may be taught to use dopamine increasing techniques such as 1) activity kindling or self-controlled hyper-arousal, 2) self-deprivation, 3) self-controlled increase of their success-startle threshold or activity kindling threshold, and 4) creation of a crisis of need or relevance, or combinations, thereof, to overcome the bad effects of an unhealthy level of adrenalin.

It has been found that endorphins also produce sensations of pleasure by uninhibiting dopamine pathways, causing more dopamine to be released into the synapses. Endorphins are peptides that may be produced by the pituitary gland and the hypothalamus in vertebrates. Endorphins may be released by laughter, or rigorous exercise that takes persons over their success-startle threshold or activity kindling threshold. The “runner's high” is one example where strenuous exercise or the high that comes from completing a challenge rather than just through the exertion takes persons over their success-startle threshold or activity kindling threshold. Endorphins may be generated in response to certain spices, such as chili peppers. In some embodiments of the present invention, the students may be taught to increase endorphin release using the aforementioned techniques to experience a “winners high.”

Students may be taught that the old brain physically resides in primitive brain structures, such as the brain stem. The old brain may be responsible for primitive drives in humans such as survival and self-preservation and/or defensiveness instinct, and recreation, such as instant gratification type pleasures. An example of the students' self-preservation, survival and/or defensiveness drives or instinct may be a primal instinct such as “fight or flight” that arises when students may be frightened because they perceive they are in danger of physical harm, or in danger of not being able to obtain necessities of life such as food, shelter, warmth and sleep. Actions or sustained right actions directed by the old brain tend toward avoidance behavior, minimizing exposure and promoting inactivity and thus have a negative effect on success as defined supra.

Although students may be instructed to de-emphasize old brain drives or instincts for recreation, r, and survival, s and to emphasize new brain Creative Ambitions and/or Creative Actions or sustained right actions and Success-Creative Activities in order to redistribute their creative energy, Eᵢ, to reallocate it to power and achieve their compelling desires and personal goal, students may be instructed in embodiments of this invention to allocate a finite amount of their creative energy, Eᵢ, for recreation, r, and survival, s, old brain activities that include spirit energizing or refreshing recreation, r, such as pleasuring in the sounds of the forest or socializing with friends or family, or exercising for maintaining one's health Students may be taught to allocate a finite amount of their creative energy, Eᵢ, to survival, a, that include self-defense, sex and reproduction or working long hours to finish a task on time.

Students may be taught that the new brain physically resides in higher brain structures such as cortical structures. Actions or sustained right actions directed by the new brain tend toward complex dynamic activity and involve adventure, logic, reason, risk taking and delaying gratification and thus have a positive effect on success as defined supra.

In embodiments of the present invention, old brain activities do not include behavioral tasks such as motivation, people skills, innovation, memory, and seeing situations in total (seeing the “big picture”). On the contrary, new brain activities of the present invention include behavioral tasks such as motivation, people skills, innovation, memory, and seeing situations in total (seeing the “big picture”).

The student may be instructed that the differences between the old and new brain set up a polarized internal conflict in the students between recreation and survival drives, on the one hand, and Creative Ambitions and/or Creative Actions or sustained right actions, on the other hand, as depicted in the at least one Success CA•rs 1 and 2 in FIG. 1B, infra. In some embodiments, the students may be taught that SLOW CA•rs activity, characterized by low probability of success, may arise from old brain structures.

In FIG. 1B, the at least one Success CA•rs 1 may be represented by an acronym “CA•rs”, wherein the first two letters of the CA•rs acronym represent the first letter of Creative Ambitions and/or Creative Actions or sustained right actions, and the third letter of the CA•rs acronym represents recreation drives or instincts and the fourth letter of the CA•rs acronym represents survival or self-protection. In FIG. 1B, the at least one Success CA•rs 1 may be represented by a triangle, wherein the student's creative energy for powering his or her Creative Ambitions and/or Creative Actions or sustained right actions and/or Success-Creative Activity may be an area E_{CA} in the at least one Success CA•rs 1, wherein the students' creative energy for powering recreation and survival may be an area E_{r,s}, and wherein the students' initial creative energy, Eᵢ, is equal to E_{CA}+E_{r,s}. The at least one Success CA•rs 1 may be primary vehicles of the students' creative energy. Therefore, the at least one Success CA•rs 1 may be primary vehicles for the students creative thoughts or sustained right thinking and creative actions or sustained right actions, since creative thoughts or sustained right thinking and creative actions or sustained right actions may be powered by their creative energies. In a step 110 of the method 1, the students may be taught to redistribute and re-balance their creative energy distribution to increase the area E_{CA} by repositioning the divider 3 in a direction of an arrow 11, thereby teaching the students to allocate more of their Creative Ambitions and/or Creative Actions or sustained right actions energy, E_{CA}, for their thoughts or sustained right thinking, actions or sustained right actions and results to power and achieve their Creative Ambitions and/or Creative Actions or sustained right actions and/or Success-Creative Activities. Hereinafter, students may be instructed to achieve their compelling desire, their personal goal and success by instructing them to utilize a Success Roadmap 50, as depicted in FIG. 1E, infra. Hereinafter, “STARS” is an acronym, wherein the first “S” represents said students' “Ideal Self,” and/or “Spirited Living or Sustained Spirit Energy,” “T” represents said students' “thoughts or sustained right thinking,” “A” represents said students' “actions or sustained right actions,” or “activities” and the last “S,” in the acronym represents “surveillance,” “self-monitoring,” and/or “self-governance.” Hereinafter, instructing students to utilize “STARS” means instructing them to power their thoughts or sustained right thinking, “T”, “actions or sustained right actions,” “A”, and “results,” “R,” inter alia, from the students' creative energy of their “Ideal Self” and/or “Spirited Living or Sustained Spirit Energy.”Hereinafter, the method, wherein the students' thoughts or sustained right thinking, “T”, “actions or sustained right actions,” “A”, and “results,” “R,” are powered by their creative energy of their “Ideal Self” and/or “Spirited Living or Sustained Spirit Energy” and subsequently subjected to “surveillance” and/or “self-monitoring” and/or “self-governance,” “S” may include the steps 51-56 of the Success Roadmap 50, as depicted in FIG. 1E, infra, and described in associated text and may be named “FAST CA•rs MAKE HOLLYWOOD STARS.” FAST CA•rs are the students' creative energy. Hollywood STARS include all their extraordinary successes. The term “Fast CA•rs Make Hollywood STARS” is a slogan that may mean the students' extraordinary successes, i.e., Hollywood STARS, may depend upon their ability to access their creative energy Fast CA•rs. Students may become a STAR by never allowing their minds to dwell upon either, too much partying (recreation), or excessive concerns about your survival. Students may become STARS by centering their minds and actions upon pursuits of a creative nature.

In some embodiments success may require the interaction of the students' Spirit and mind (Thoughts) to set off a sequence of Creative Actions, CA that bind together the students' desired Results under their watchful Surveillance and/or Self-monitoring and/or Self/governance.

In some embodiments, “STARS” includes powering the students' thoughts or sustained right thinking, “T” and “actions or sustained right actions,” “A” by providing the students' creative energy from FAST CA•rs resulting from the Success CA•rs redistributions 15, 16, and 35, as depicted in FIGS. 1C, 1D, and IF, as depicted, infra, and described in step 115 of the method 1, as depicted in FIG. 1A, supra.

FIG. 1C depicts FIG. 1B, illustrating a Success CA•rs 15 redistribution in a direction of the arrow 5, wherein a portion of the student's initial creative energy, Eᵢ, in the at least one initial Success CA•rs 1, may be equivalent to E_{CA}, and a portion of the student's final creative energy, E_{f}, may be equivalent to E_{CA′} in an at least one final Success CA•rs 2, after students have redistributed and re-balanced their creative energy so as to allocate more Creative Ambitions energy and/or Creative Actions or sustained right actions energy for powering their Creative Ambitions and/or Creative Actions or sustained right actions and/or Success-Creative Activity, according to embodiments of the present invention. The Success CA•rs 15 redistribution may be a method of attaining personal goals by performing new brain activities, in accordance with the method 1, as depicted in FIG. 1A, infra, and described in associated text.

In the Success CA•rs redistribution 15 depicted in FIG. 1C, a remaining portion of the student's initial creative energy, Eᵢ, may be equivalent to E_{r.s} in the at least one initial Success CA•rs 1, and a remaining portion of the student's final creative energy, E_{f}, may be equivalent to E_{r′,s′} in an at least one final Success CA•rs 2 after the students have redistributed and re-balanced their creative energy so as to allocate more Creative Ambitions and/or Creative Actions or sustained right actions energy, E_{CA′}, for powering their Creative Ambitions and/or Creative Actions or sustained right actions and/or Success-Creative Activity. E_{r,s} may be equivalent to a sum of creative energy for powering r and s in the at least one initial Success CA•rs 1, and E_{r′,s′} may be equivalent to a sum of creative energy for r′ and s′, in the at least one final Success CA•rs 2. Hereinafter, E_{CA} represents initial Creative Ambitions and/or Creative Actions or sustained right actions energy in the at least one initial Success CA•rs 1, and E_{CA′} represents final Creative Ambitions and/or Creative Actions or sustained right actions energy in the at least one final Success CA•rs 2. Both the initial and final Success CA•rs 1 and 2 may be represented by any plane or solid geometric figure such as a circle, square, rectangle, or a sphere, cube, parallelepiped and the like. The at least one initial and final Success CA•rs 1 and 2 may be represented by different plane or solid geometric figures. In FIG. 1C, the initial and final CA•rs 1 and 2 states may be represented by triangles, wherein the students' creative energy for achieving their Creative Ambitions and/or Creative Actions or sustained right actions and/or Success-Creative Activity may be an area Eᵢ in the at least one Success CA•rs 1 and an area E_{f} in the at least one Success CA•rs 2, and wherein Eᵢ=E_{CA}+E_{r,s} and E_{f}=E_{CA′}+E_{r′,s′}. The Success CA•rs redistribution 15 in the direction of the arrow 5, depicted in FIG. 1C, shows CA′ having E_{CA′}>E_{CA′}. Therefore, FIG. 1C depicts transformation of a SLOW Success CA•rs 1 into a FAST Success CA•rs 2 because the area of CA is greater than the area of CA′. Hereinafter, the students may be instructed that FAST CA•rs 2 have a high yield of success and SLOW CA•rs 1 have a low yield of success, as in the step 105 of a method 1, herein.

There is a possibility that success may fail to arouse a feeling of happiness in what has been accomplished. It has been found that when success is in harmony with the students' Creative Ambitions and/or Creative Actions or sustained right actions, for example, when their personal values and beliefs and those of society are in harmony, the probability that the success will arouse a feeling of unhappiness is low. Hereinafter, success may be in harmony with the students' Creative Ambitions and/or Creative Actions or sustained right actions when the creative activities that are the manifestation of the success resonate, i.e. are consistent with and constructively in-phase with the students' Creative Ambitions and/or Creative Actions or sustained right actions.

To be an effective redistribution of the students' creative energy, the final creative energy E_{CA′} should be greater than the initial creative energy E_{CA}, but the relationship of Eᵢ and E_{f} may be one of Eᵢ=E_{f}, Eᵢ<E_{f} or Eᵢ>E_{f}. Therefore, an effective CA•rs redistribution may require the area E_{CA′}>E_{CA}, regardless what plane or solid geometric figure may be used to represent the initial and final CA•rs 1 and 2 states. In the Success CA•rs redistribution 15, students have been instructed to redistribute and re-balance their Creative Ambitions and/or Creative Actions or sustained right actions energy, E_{CA}, so that more of their final Creative Ambitions and/or Creative Actions or sustained right actions energy, E_{CA′}, may be available to power his or her Creative Ambitions and/or Creative Actions or sustained right actions and creative activities. In so doing, the area of E_{CA′} may be made larger than the area of E_{CA} by moving a position of divider 3 in the triangle 1 in a direction of an arrow 11 to a position of a divider 4 of the triangle 2. Therefore, the position of divider 4 in the final Success CA•rs 2 state relative to the divider 3 in the initial CA•rs state should be such that the area of E_{CA′}>E_{CA}, since the student has allocated more creative energy to power his or her Creative Ambitions and/or Creative Actions or sustained right actions and/or Success-Creative Activity in the CA•rs redistribution 15.

FIG. 1D depicts a Success CA•rs 16 redistribution in a direction of the arrow 8, wherein a portion of the student's Dwelling Time, DTᵢ, in the at least one initial Success CA•rs 1, may be equivalent to a Dwelling Time DT_{CA}, and a portion of the student's final Dwelling Time, DT_{f}, may be equivalent to DT_{CA′} in the at least one final Success CA•rs 2 after the students have redistributed and re-balanced their Dwelling Time so as to allocate more of the students' Dwelling Time for achieving their Creative Ambitions and/or Creative Actions or sustained right actions and/or Success-Creative Activity, according to embodiments of the present invention.

In addition, FIG. 1D depicts a Success CA•rs 16 redistribution in the direction of the arrow 8, wherein a remaining portion of the students' Dwelling Time, DTᵢ, may be equivalent to DTᵣₛ in the at least one initial Success CA•rs 6, and a remaining portion of the students' final Dwelling Time, DT_{f}, may be equivalent to DT_{f′s′} in the at least one final Success CA•rs 7 after the students have redistributed and re-balanced their Dwelling Time so as to allocate more Dwelling Time for achieving their Creative Ambitions and/or Creative Actions or sustained right actions and/or Success-Creative Activity. DTᵣₛ may be equivalent to a sum of Dwelling Time for achieving r and a, and DT_{r′s′} may be equivalent to a sum of Dwelling Time for achieving r′ and s′, in a final Success CA•rs 7. Hereinafter, CA represents Creative Ambitions and/or Creative Actions or sustained right actions, an r represents recreation, and s represents survival and self-protection in the initial CA•rs 6 state and CA′ means Creative Ambitions and/or Creative Actions or sustained right actions, r′ means recreation, and s′ means survival and/or self-protection in the final CA•rs 7 state. As in FIG. 1C, supra, both the initial and final CA•rs 6 and 7 states may be represented by any plane or solid geometric figure such as a circle, square, rectangle, or a sphere, cube, parallelepiped and the like. The initial and final CA•rs 6 and 7 states may be represented by different plane or solid geometric figures. In FIG. 1D, the initial and final CA•rs 6 and 7 states may be represented by triangles, wherein the student's Dwelling Time for achieving his or her Creative Ambitions and/or Creative Actions or sustained right actions and/or Success-Creative Activity may be an area DT_{CA} in the triangle 6 and an area DT_{CA′} in the triangle 7, and wherein DTᵢ=DT_{CA}+DTᵣₛ and DT_{f}=DT_{CA′}+DT_{r′s′}. The Success CA•rs redistribution 16 in the direction of the arrow 8, depicted in FIG. 1D, showing CA′ having greater Dwelling Time than CA may result from the student's redistribution and re-balancing of his or her Dwelling Time so as to allocate more Dwelling Time to achieve his or her Creative Ambitions and/or Creative Actions or sustained right actions and/or Success-Creative Activity. To be an effective redistribution of the student's Dwelling Time, the final Dwelling Time DT_{CA′} should be greater than the initial Dwelling Time DT_{CA}, and the relationship of DTᵢ and DT_{f} may be one of DTᵢ=DT_{f}. Therefore, an effective Success CA•rs 16 redistribution may require the area DT_{CA′}>DT_{CA}, regardless what plane or solid geometric figure may be used to represent the initial and final CA•rs states. In so doing, the area of DT_{CA′} may be made larger than the area of DT_{CA} by moving a position of divider 9 in the Success CA•rs 6 in a direction of an arrow 12 to a position of a divider 10 of the Success CA•rs 7. Therefore, the position of divider 10 in the final Success CA•rs 7 state relative to the divider 9 in the initial CA•rs 6 state should be such that the area of DT_{CA′}>DT_{CA}, since the student has allocated more Dwelling Time to power his or her Creative Ambitions and/or Creative Actions or sustained right actions and/or Success-Creative Activity in the CA•rs redistribution 16.

FIG. 1A depicts an overall flowchart of a method 1 for teaching success according to the present invention. In step 95, students may be instructed to identify a compelling desire or personal goal. In step 100, students may be instructed to list possible or potential causes for failing to achieve a personal goal, that is, their creative resistance, and possible or potential substitute new brain activities for achieving the personal goal. Creative resistances may be barriers to success. The student may be taught that as a toddler and youngster, they were carefree and filled with curiosity and creative energy, but with the passage of time, they acquired from their parents greater responsibility for ensuring their own personal safety. Further, while, their primary caregivers continually warned them of the dangers of the world, they may have experienced some negative events such as disappointment, tragedy, loss or trauma. Consequently, they may have begun to withdraw and may have become increasingly fearful and defensive, that may have resulted in limiting their curiosity and creative energy. As they became increasingly preoccupied with concerns of survival and self-preservation and recreation for instant gratification, they may have begun to suppress their creativity and their carefree creative nature. As they retreated and played it safe, an imbalance was created in their lives, with a greater share of their creative energy being channeled towards survival, self-preservation, and recreation, and less time towards creative pursuits.

The student may be taught that the biological roots for self-preservation or survival and recreation in the at least one Success CA•rs 1 may arise from primitive evolutionary drives or instincts and may be old brain activity that result in SLOW CA•rs that may be characterized by a low probability of success. In contrast to FAST CA•rs, SLOW CA•rs may be characterized by a low probability of success because they may establish a resistance in the students towards engaging in FAST CA•rs activities, such as creative activities that may utilize the new brain. Alternatively, students may be taught that old brain activity may inhibit willingness to express the students' Creative Ambitions and/or Creative Actions or sustained right actions, thereby inhibiting the students' comfort with exposure or standing out in a crowd or leadership and inhibiting the students' success-creative activities. Hereinafter, “low probability of success” means failure to achieve the students' compelling desire or personal goal. Failure includes performing and achieving far below the students' true possible or potential abilities. Students may be taught that failure includes the students' inability each day to resume and maintain the integrity of their focus, attention, interest, and pleasure in pursuing their desired goals. Hereinafter, old brain activities include self-preservation or survival fear, worry, fight or flight reflexes, impulsive responses, recreation, i.e., over-indulgence in play, or in simple pleasures or in matters of instant gratification. It may be explained to the student that the old brain preserved a “biological hardwiring for survival” when the new brain evolved.

Examples of possible or potential questions the students may be taught to ask themselves to characterize whether they may be allocating sufficient creative energy as FAST CA•rs instead of SLOW CA•rs include, but are not limited to: 1) Do I often fail to follow through with important tasks? 2) Do I often lose interest quickly? 3) Do I often fail to set goals and maintain goals? 4) Do I often fail to complete projects? 5) Why do I fail to maintain a diet? 6) Why do I postpone changing my career? 7) Why do I lose enthusiasm for new projects? 8) Do I often feel empty and dissatisfied? 9) How can I be more consistent in following through? 10) How can I raise my level of energy and enthusiasm? 11) How can I avoid future regret because of my inappropriate behavior or regrettable actions or sustained right actions?

Referring to the step 100 of the method 1, the student may be instructed to list possible or potential old brain activities from which the causes for SLOW CA•rs listed in the step 100 may arise, and to list possible or potential new brain activities to overcome these causes. The list of reasons may include, but may not be limited to one of the following: the student may list “old brain” activities such as survival, self-preservation, and/or defensiveness and/or reproduction or sex and/or recreation drives or instincts as reasons for failing to achieve the aforementioned personal goals. Alternatively, the student may list “old brain” activities that include, but are not limited to: 1) thinking too small; 2) thinking too little of ourselves and our capabilities; 3) preferring to settle for less; 4) failing to initiate and sustain enough interest; and 5) playing it safe.

Referring to the step 100 of the method 1, the student may list “new brain” activities to achieve the aforementioned personal goals that the students listed in the step 95 of the method 1. Hereinafter, “new brain” activities are activities that arise from the student's creativity such as imagining, dreaming, and boundary-less problem solving which come from the students' free spirit or sense of omnipotence. Herinafter, the “sense of omnipotence” means the ability to achieve boundlessly. Students may be taught they may be born with a boundary-less or free spirit. Alternatively, the student may be taught that the greatness (omnipotence) the students may see in others may also be greatness that is within the students. However, that free spirit may become restricted or inhibited by life's experiences that introduce and reinforce doubt in the students' minds about what is a reachable, a realistic or a reasonable goal or activity. The student may be taught this may result in a loss of creativity. The aforementioned new brain activities may be driven by “activity drives” such as work, charity, applying interactive synergy and/or Creative Ambition and/or Creative Activity and/or Creative Action, as in success FAST CA•rs, to achieve the aforementioned personal goals. Hereinafter, “interactive synergy” means the interaction of two or more agents or forces so that their combined effect is greater than the sum of their individual effects. Alternatively, “new brain” activities may be activities driven by “experiential drives” such as a need for love, companionship, appreciation, understanding, having a sense of meaningfulness, and having a sense of purpose. Alternatively, “new brain” activities may be activities driven by “quality of life drives” such as need for belonging, affiliation, acceptance, happiness, contentment, special ness and peace of mind. Alternatively, the new brain easily handles problems such as logic, objectivity, precision, analysis, and technology. Steps 95 and 100 of the method 1 are preparatory steps. Being successful individuals may require increased use of the aforementioned new brain activities and a decreased use of the aforementioned old brain activities in their day to day lives.

In step 105 of the method 1, the students may be instructed that the FAST CA•rs may have a high yield of success and SLOW CA•rs may have a low yield of success. The students may be instructed that the acronyms FAST CA•rs and SLOW CA•rs describe opposite states of the Success CA•rs redistributions 15 and 16 of FIGS. 1C and 1D, as depicted supra, and described herein. In the step 100, E_{CA} of Success CA•rs 1 may be less than E_{CA′} of Success CA•rs 2 because the line 3 has moved in the direction of the arrow 11 to a position of the line 4, resulting in the area E_{CA} being less than the area E_{CA′} Creative Ambition and/or Creative Action, may be opposite recreation and survival. The opposites Creative Ambitions and/or and Creative Actions or sustained right actions are represented to the student as FAST CA•rs activity, and recreation (or short-lived pleasure) and survival are represented to the student as the two SLOW CA•rs activities. The features of FAST CA•rs activities are: they have a high yield for success, are activities that power Creative Ambitions and/or Creative Actions or sustained right actions and are success excitatory. FAST CA•rs activities include activities that may require creativity, wisdom, problem solving, spirituality, and activities that elicit such complex emotions such as exhilaration. Examples of FAST CA•rs activities include the aforementioned new brain activities. The features of SLOW CA•rs activities include: they have a low yield for success, are the baseline automatic default responses, are creative liabilities, i.e. activities that drain a students' creative energy and are success inhibitors. SLOW CAR activities may also include old brain activities. Examples of SLOW CAR recreation (or pleasure) activities include any compulsive pursuits that may only serve to distract students from implementing or completing new brain activities to achieve their personal goal. SLOW CAR recreation (or pleasure) activities include activities that provide instant gratification such as compulsive drinking or eating or habitual behavior. SLOW CAR survival activities include activities based on fear, worry and may invoke flight or fight responses or other impulsive responses. SLOW CAR survival activities include activities such as over-working, and being a perfectionist. A persons' creative energy may be split between the SLOW and FAST CA•rs.

In step 110 of the method 1, the students may be instructed to select and implement at least one of the possible or potential new brain activities associated with the FAST CA•rs.

In the step 115, the students may be instructed to utilize a success roadmap to achieve FAST CA•rs. FIG. 1E depicts a Success Roadmap 50 in which their creative energy flows from their Ideal Self and/or their Spirited Living or Sustained Spirit Energy, S, to power their thoughts or sustained right thinking, T, actions or sustained right actions, A and their results, R. In a surveillance and/or self-monitoring and/or self-governance step, the students may consciously ask whether they have effectively allocated their dwelling time and creative energy to achieve their compelling desire or personal goal. The students may be instructed to utilize, the Success Roadmap 50 in the step 115 of the method 1, as depicted in FIG. 1A. The Success Roadmap 50 comprises: a step 51 in which the students' creative energy may flow from their Ideal Self and/or their Spirited Living or Sustained Spirit Energy to power thoughts or sustained right thinking, T, such as right or correct thoughts or sustained right thinking, wherein the rightness or correctness of the thoughts or sustained right thinking, T, may be based on FAST CA•rs thoughts or on whether the students determine that they have achieved their compelling desire and/or their personal goal; a step 52 in which the students' creative energy may flow from their Ideal Self and/or their Spirited Living or Sustained Spirit Energy throght their thoughts, T, to power their actions or sustained right actions, A, such as right or correct actions or sustained right actions, wherein the rightness or correctness of the actions or sustained right actions, A, may be based on FAST CA•rs actions and/or whether the students determine that they have achieved their compelling desire and/or their personal goal; a step 54, in which the students' creative energy may flow from their Ideal Self and/or their Spirited Living or Sustained Spirit Energy through their thoughts and actions to power their results, R, such as right or correct results, wherein the rightness or correctness of the results, R, may be based on whether the students determine that they have achieved their compelling desire and/or their personal goal. In steps 51, 52 and 54, the Law of Positive Natural Consequences may be taught to the student. The Law of Positive Natural Consequences states that outcome is a natural outflow from action or inaction. The Law of Positive Natural Consequences controls all a students' interactions or sustained right actions with the universe. Technically the Law of Positive Natural Consequences is an “IF . . . THEN” sequential dyad. In the steps 51, 52 and 54, the student is taught the consequences of the Law of Positive Natural Consequences. First, the Law of Positive Natural Consequences controls the time-movement of all objects (tangible and intangible); that is, how a person gets from here to there, that is, how a person acquires success, in accordance with the present invention. Second, like baking a cake, sequence guarantees outcome. Third, good outcome may require consistent, positive actions or sustained right actions.

The Success Roadmap 50 includes a surveillance and/or self-monitoring and/or self-governance step, 56, in which students may be instructed to ask whether they have effectively allocated their dwelling time and creative energy to achieve their compelling desire or personal goal, and if they have achieved their good compelling desire or personal goal. In the step 56, if the answer is “NO”, the students may be taught to repeat steps 51-56 of the Success Roadmap 50. Alternatively, they may consciously choose to abandon or postpone such intended compelling desire or personal goal. If the answer is “YES”, the students may be taught that a purpose of the surveillance and/or self-monitoring and/or self-governance operation, S, in the Success Roadmap 50 is to enable the students to continually test the rightness or correctness of their thoughts or sustained right thinking, T, actions or sustained right actions, A and/or their results, R the results, R. The students may be taught that their thoughts or sustained right thinking, T, actions or sustained right actions, A and/or their results, R may be right if they feel a sense of Happiness, Contentment, and/or Peace of Mind, after they have achieved success in regard to achieving their compelling desire or personal goal, as in step 95 of the method 1, as depicted in FIG. 1A. A compelling desire or personal goal can also include helping others achieve Happiness, Contentment, Peace of Mind and/or success for themselves. Surveillance and/or self-monitoring and/or self-governance may be tests for whether the students have preserved their Happiness, Contentment, and/or Peace of Mind, after they have achieved Success in regard to achieving their compelling desire or personal goal, as in step 95 of the method 1, as depicted in FIG. 1A.

The students may be taught success FAST CA•rs 58 may provide creative energy in the form of Creative Ambitions and/or Creative Actions or sustained right actions, CA, as depicted in FIGS. 1C, 1D, and 1F, supra, for powering their thoughts or sustained right thinking, T, in a direction of an arrow 53. In some embodiments, the students may be taught creative energy from their Ideal Self and/or Spirited Living or Sustained Spirit Energy, S, may be provided for powering their success FAST CA•rs 58, in a direction of an arrow 53′ and/or creative energy from their success FAST CA•rs for powering their thoughts or sustained right thinking in the direction of the arrow 53.

The students may be taught success FAST CA•rs 59 may provide creative energy in the form of Creative Ambitions and/or Creative Actions or sustained right actions, CA, recreation, as depicted in FIGS. 1C and 1D, supra, for powering their actions or sustained right actions, A, in a direction of an arrow 55. In some embodiments, the students may be taught creative energy from their thoughts or sustained right thinking, T, and/or Ideal Self and/or Spirited Living or Sustained Spirit Energy, S, may be provided for powering their success FAST CA•rs 59, in a direction of an arrow 55′ and/or creative energy from their success FAST CA•rs for powering their thoughts or sustained right thinking in the direction of the arrow 55.

FIG. 1G depicts one embodiment of an “Ideal Self” and/or “Spirited Living or Sustained Spirit Energy” success CA•rs 70, wherein the students have been taught to allocate their success-creative energy in proportion to an area of each labeled portion of the success CA•rs 70 in order to power and achieve their Creative Ambitions and/or Creative Actions or sustained right actions, CA, as in the success CA•rs 1, as depicted in FIG. 1A, supra. In FIG. 1G, the students may have been instructed to allocate a lowest level of their creative energy to primitive needs such as self-preservation, survival, reproduction, sex and recreation for simple pleasure. The students have been instructed to allocate a second level of their creative energy to expressive needs to improve their quality of life through activity drives, including, but not limited to, creativity, work charitable giving, and interactive synergy. In FIG. 1G, primitive and expressive needs have been allocated generally to activity drives.

In FIG. 1G, the students may also have been instructed to allocate an intermediate and highest levels of their success-creative energy to Emotional Needs for powering their Emotional drives or instincts, including, but not limited to, feeling of love, specialnesss, being appreciated, being understood, having a sense of feelings of meaningfulness, being valued, having a sense of belonging, having a sense of affiliation, being accepted, being connected, having peace of mind, having contentment, having legacy, having balance, having fulfillment and being in harmony. Hereinafter, Quality of Life drives or instincts include Emotional drives or instincts and the Expressive Needs portion of Activity drives or instincts. Hereinafter, happiness means a balanced embodiment of activity drives, quality of life drives, and emotional drives to achieve a sense of completeness and harmony. Happiness is the students' moment to moment ability to look and see far beyond the negative, so as to experience the beauty and perfect-ness of this world (and of those around you); and, with great love and excitement in your heart, immerse yourself in the creative possibilities of now.

In the step 115 of the method 1, students may be taught that performing the Success CA•rs redistributions 15 and 16 may result in success in achieving their personal goals. Students may be taught that performing the Success CA•rs redistributions 15 and 16 may result from increased use of the new brain activities and a decreased use of the old brain activities in their day to day lives, transforming their SLOW CA•rs to FAST CA•rs, in accordance with the method 1 of the present invention. In the step 115 of the method 1, the student may be instructed to allocate more creative energy and Dwelling Time to power and achieve his or her Creative Ambitions and/or Creative Actions or sustained right actions and/or Success-Creative Activity, according to the Success CA•rs 15 and 16 redistributions as depicted in FIGS. 1B and 1C and described supra, to achieve their personal goals, success, happiness and legacy. When students are instructed to allocate more Creative Ambition and/or Creative Actions or sustained right actions energy, E_{CA}, and Dwelling Time to power and achieve their Creative Ambitions and/or Creative Actions or sustained right actions and/or Success-Creative Activity in the CA•rs redistribution as depicted in FIGS. 1B and 1C and described supra, they may achieve their personal goals, success, happiness and legacy. In the CA•rs redistribution, the student may increase his or her Creative Ambitions and/or Creative Actions or sustained right actions Dwelling Time, DT_{CA′} relative to the student's Creative Ambitions and/or Creative Actions or sustained right actions Dwelling Time, DT_{CA}, as depicted in FIG. 1B and described in associated text. Hereinafter, Dwelling Time may be the time the student invests thinking about and performing any activity. Dwelling Time can be constructive or destructive. Constructive Dwelling Time may be rooted in Creative Ambitions and/or Creative Actions or sustained right actions and in Success-Creative Activity. Constructive Dwelling Time may be time that directly powers success. Destructive Dwelling Time may be rooted in self-preservation and recreation. Destructive Dwelling Time may displace Success-Creative activity. Students may be taught to do surveillance and/or self-monitoring and/or self-governance, in which they are taught to optimize a probability of success of achieving their personal goals by monitoring their Constructive Dwelling Time. Students may be instructed to perform the Success CA•rs redistributions 15 and 16 to de-emphasize recreation and survival activities by re-distributing and re-balancing their Dwelling Time so that more of the students' Success-Creative activity may be allocated toward Creative Ambitions and/or Creative Actions or sustained right actions. New brain activities are helpful in achieving a student's personal goal; old brain activities are detrimental to achieving the student's personal goal.

In some embodiments of the present invention, in step 115 of the method 1, students may be instructed to de-emphasize old brain activities by allocating more creative energy and dwelling time to power and achieve their personal goals and FAST CA•rs based on the listing of new and old brain activities that result in Fast CA•rs, supra, listed in the step 100 of the method 1.

FIG. 1H depicts an embodiment of the step 115 of the method 1, wherein the students may be instructed to redistribute and rebalance their initial foreground creative energy, FGEᵢ, as in a Success CA•rs redistribution 35 in a direction of the arrow 37, as depicted in FIG. 1G and described infra. In FIG. 1H, the students may have redistributed their initial foreground energy, FGEᵢ, such that FGE_{CA′}>FGE_{CA} to accomplish the students' moment-to-moment thoughts or sustained right thinking and behaviors. Creative energy includes foreground creative energy. “Foreground energy” is a portion of a students' creative energy that may be allocated to power in-progress activities in order to achieve the students' personal goal. The students may be instructed to distinguish between personal goals that may have an immediate need from personal goals that may be achieved later. In this foreground creative mode, a task executing in foreground is one able to accept input from and return output to the user in contrast to one running in the background. Normally, there may be more than one foreground task per student to be accomplished. Hereinafter, accomplishing more than one task per student may be termed “multi-resulting.” In the foreground creative mode, instructing the students, as depicted in FIGS. 1G and 1H, and described, herein, to allocate their “foreground energy” to accomplish their moment-to-moment thoughts or sustained right thinking and behaviors may avoid confusion that may result from multi-resulting.

FIG. 1H depicts an embodiment, Overcoming Resistance, of the step 115 of the method 1, comprising a step 112, instructing students to utilize activity kindling or controlled hyper-arousal to overcome their naturally occurring stop reflex, or a step 114, instructing students to utilize self-deprivation to overcome, suppress or override their naturally occurring stop reflex, or a step 116, instructing students to increase their success startle threshold or activity kindling threshold, or a step 118, instructing students to create a crisis of need or relevance. In the step 112, the students may be instructed to utilize activity kindling or hyper-arousal to overcome their naturally occurring stop reflex that may be a barrier preventing allocation of their creative energy, E_{f}, in order to achieve their Creative Ambitions and/or Creative Actions or sustained right actions, as in a Success CA•rs redistributions 15, 16, and 35 as in FIGS. 1C, 1D and 1F. Hereinafter, kindling means the electrophysiological changes that occur in the brain as a result of repeated intermittent exposure to a sub-threshold electrical or chemical stimulus (as one causing seizures) so that there develops a usually permanent decrease in the threshold or barrier to action or activity. Hereinafter, “hyper-arousal” means a state of elevated or increased alertness, focus, interest, awareness or wakefulness. “Hyper-arousal” may also mean an enhanced state of sensory sensitivity accompanied by an exaggerated intensity of behaviors whose purpose is to detect threats, for example, hyper-vigilance. Hereinafter, the “stop reflex” is a reflex that arises from a students' natural resistance to change, such as, for example, the Natural Protective Resistance (NPR) to change or novelty. The “stop reflex” may arise from homeostasis, a term that describes a students' bodies' natural tendency to preserve their physiological equilibria, such as, for example, a homeostatic regulator that preserves the current state of affairs, such as the body's ability and drive to maintain a constant fixed body temperature. Students may prepare for action if they are threatened by the environment (or informed of an approaching pleasure or danger). They may activate reserves of energy that may be a barrier preventing allocation of their creative energy, E_{f}, to achieve their Creative Ambitions and/or Creative Actions or sustained right actions, as in a Success CA•rs redistributions 15, 16, and 35 as in FIGS. 1C, 1D and 1F, and produce certain hormones such as adrenalin, which prepares them for conflict or flight, such as for example, the survival instinct reflex. This activation can be manifested in visible physiological reactions or sustained right actions. Their heart beats and respiration may quicken in the presence of emotion, perceived danger, or physical effort. Their faces may turn red or pale and their bodies may perspire. They may experience shortness of breath, cold sweats, shivering, or trembling legs. In preparation for fight or flight, physiological change gets converted into feelings of anxiety which increase the students fear. The fear then becomes the resistance to creativity.

Homeostasis can be a voluntary response to paired stimuli, e.g., to drink when one is thirsty, to eat when hungry, to put on clothing when cold, to open a window when one is too warm, or involuntary response to paired stimuli, e.g. shivering, or sweating when one has a fever or may be too cold or hot. Here, the “paired stimuli” mean the stimulus of the pleasure to drink in response to the stimulus to relieve the pain of thirst, the stimulus of the pleasure to eat in response to the stimulus to relieve the pain of hunger, etc. In either voluntary or involuntary cases of homeostasis, students may be taught that the likelihood that they may overcome the stop reflex of homeostasis may depend on their control of the “paired stimuli,” that may be opposite human sensations such as pleasure and pain, hunger and satiety, or emotions, such as love and hate.

FIG. 1I depicts the students' creative energy, such as their perceived pleasure, as in equation (1), infra, versus time that may power students' Creative Ambitions. The students' perceived pleasure is shown as being either greater than, equal to or less than the students' activity kindling or de-kindling threshold or hyper-arousal or hyper-dearousal threshold versus time. Hereinafter, “activity dekindling threshold” and “hyper-dearousal threshold” are opposite of “activity kindling threshold” and “hyper-arousal threshold,” respectively. The broken curve of FIG. 11 depicts activity dekindling or controlled hyper-dearousal, wherein a high r/s (i.e., high recreation, r, and/or survival, s,) activity having the students' creative energy inefficiently allocated to survival, s, and/or recreation, r, activity may be dekindled, i.e. directed below the “activity dekindling threshold” and “hyper-dearousal threshold” over time by instructing the students to link the high r/s activity to a low perceived pleasure, that may be less than 50%, as defined in equation (1) supra. By instructing the students to link the high r/s activity to the low perceived pleasure, the students may be taught to stop doing the high r/s activity. It has been found that students will stop doing the high r/s activity when the perceived pleasure is less than 50%, resulting in directing the high r/s activity from an “activity field,” as in FIG. 1I, to a thought field. In contrast, the solid curve of FIG. 1I depicts activity kindling or controlled hyper-arousal, wherein a high Creative Ambitions, CA, activity may be kindled, i.e. directed above the “activity kindling threshold” and “hyper-arousal threshold” over time by instructing the students to recognize that the activity linked to the high Creative Ambitions, CA activity may have a high perceived pleasure, as defined in equation (1) supra. By instructing the students to link the high Creative Ambitions, CA, activity to the high perceived pleasure, the students may be taught to start doing the high CA activity. It has been found that students will start doing the high CA activity when the perceived pleasure is greater than 50%, resulting in directing the high CA activity from the “thought field” as in FIG. 1I, to the “activity field,” as in FIG. 1I, to a though field. It has been found that teaching students identify high CA activities that have a perceived pleasure greater than 50% enable them to gain leverage over barriers to implementation of the creative activities they have identified to help them achieve their compelling desire or personal goal. The technique in FIG. 1I may be used by the students to transform their creative thought into creative action. FIG. 1I, teaches the students that Perceived Pleasure, as in equation (1), infra, may increase when the students kindle their high CA activities resulting in doing the activities that the students have identified may be required to achieve their compelling desires or personal goal, i.e. success. In like manner, FIG. 1I teaches the students that Perceived Pleasure, as in equation (1), infra, may increase when the students redistribute and re-balance their creative energy to allocate more creative energy to their Creative Ambitions, CA, thereby losing r/s, as depicted in FIG. 1I. FIG. 1I teaches the students to allocate r/s energy to provide the energy to transform their creative thought into creative action. It has been found that the loss in r/s energy may be equivalent to the gain in CA energy, which may also be equivalent to the gain in perceived pleasure energy.

It has been found that students should increase activity kindling or hyper-arousal intensity to an activity kindling or hyper-arousal threshold level of perceived pleasure associated with an activity, in order to overcome the stop reflex due to homeostasis in order to cause students to engage in the activity and/or carry it out. It has also been found that a likelihood that students will engage in the activity may be proportional to an activity kindling level or a controlled hyper-arousal level of the students.

Therefore, in the step 112, students may be taught activity kindling or controlled hyper-arousal techniques and that they may overcome either voluntary or involuntary homeostasis, and that may promote the students' FAST CA•rs activities such as, for example, new success. This may be because it has been found that activity kindling or controlled hyper-arousal in excess of the activity kindling or hyper-arousal threshold and in excess of the energy of aroused interest in recreation, r, or survival, s, or self-preservation, s, may overcome the students' stop reflex due to homeostasis, thereby causing students to engage in the activity and/or carry it out. In some embodiments in which the students' personal goal may include behavior displacement, it has been found that teaching students to associate more pleasure with the behavior to be activated and more pain with the behavior to be suppressed may be an effective activity kindling or controlled hyper-arousal technique. The students may be taught that activity kindling or controlled hyper-arousal that associates pleasure with activities to be activated attracts students to engage in the activity, but activity dekindling or controlled hyper-dearousal that associates pain or discomfort with activities to be suppressed causes students to withdraw from the activity to be suppressed. It has been found that activity kindling or controlled hyper-arousal may effectively stimulate activities such as working to finish a task on time in competition with other activities selected from the group consisting of watching television, playing, or reading, going to the gym, new success and combinations thereof. Alternatively, activity kindling or controlled hyper-arousal may effectively stimulate new success, effectively displacing other activities selected from the group consisting of watching television, playing, or reading, going to the gym, working and combinations thereof. In some embodiments, the controlled hyper-arousal may be the students' conviction that their personal goal justifies “going all out,” such as, for example deciding to become a physician because the student can not accept not becoming a physician.

A student may be taught that activity kindling or hyper-arousal may be utilized for energizing new success when it may be internally controlled. Alternatively, activity kindling or hyper-arousal may be externally controlled, for example, by the advertising industry. Advertising expensive clothing such as women's fashion may be an example of externally controlled hyper-arousal or externally controlled activity kindling, wherein customers may be enticed to buy articles by advertisers representing the articles to possible or potential customers as unnaturally or unrealistically desirable, beautiful, or sexually appealing. This could cause the students to displace, suppress, or abandon activities of Creative Ambition, CA. Students may be taught a benefit to internally controlling hyper-arousal or internally controlling activity kindling, is that the students may choose to pursue new success instead of being enticed to buy articles by advertisers who represent the articles to possible or potential customers as unnaturally or unrealistically desirable, beautiful, or sexually appealing. Students may be taught to increase the likelihood of achieving their creative pursuits and/or personal goal by manipulatively increasing a hyper-arousal adrenaline effect the students may associate with their creative pursuits and/or personal goal. Students may be taught to associate pleasure to present success and new success activities, and associate pain for recreation or survival activities such as working, playing, watching television, or going to the gym since it has been found that increasing the intensity of pleasure associated with an activity increases the likelihood that students will engage in it and/or carry it out.

In the step 114 of the method 1, as depicted in FIG. 1H, supra, the students may be instructed to utilize self-deprivation to overcome their naturally occurring stop reflex due to homeostasis, thereby causing students to engage in the activity and/or carry it out. The students may be taught that self-deprivation may mean deferred or delayed gratification and that these may be new brain activities that may arise from complex, dynamic brain activity. Self-deprivation includes voluntarily giving up or losing relative or perceived pleasure associated with the activity being deprived. Therefore, self-deprivation and instant gratification may be opposites because self-deprivation may be a new brain activity and instant gratification may be an old brain activity. The students may be taught to have confidence in self-deprivation and/or delayed gratification if they are given a larger reward for engaging in and/or carrying out the activity in the future than if they engage in and/or carry out the same activity immediately, such as, for example, deferring pre-marital sex until they are committed to a monogamous relationship, instead of accepting a higher risk of being exposed to a sexually transmitted disease from a polygamous partner.

In the step 116 of the method 1, as depicted in FIG. 1H, supra, the students may be instructed to focus their attention on the Creative Ambitions, CA, and/or Creative Actions or sustained right actions, CA, and/or productive activities related to carrying out their compelling desire and/or personal goal, as in the step 95 of the method 1, supra. By focusing on activities the students identify that will help them achieve their compelling desires and/or personal goal, students may induce success startles that are specific to carrying out their compelling desires and/or their personal goal. A problem is that normal human brains generate competing voluntary and involuntary success startles. In healthy brains, involuntary success startles may be controlled by a balance of adrenaline and dopamine and/or endorphins. We have described how brains with unhealthy lesions in the frontal lobe or people diagnosed with attention deficit syndrome have random uncontrolled success startles such that they try to give their attention to every activity they imagine. Focusing accomplishes two results that help students achieve their compelling desires and/or their personal goal. Firstly, focusing on creative activities increases an intensity of their success startles, and secondly, focusing on creative activities increases their success startle threshold and/or kindling and/or activity thresholds for Creative Ambition, CA, Creative Action, CA and/or productive actions or sustained right actions identified by the students for carrying out their compelling desires and/or their personal goal. As to the first result, focusing on the activity to be carried out increases the success startle intensity for that activity relative to the numerous other competing success startles in a normal or unhealthy brain. As to the second result, it has been found that focusing raises the success startle threshold and/or kindling and/or action threshold for success creative activities relative to recreation (or pleasure) r, and self-preservation, s activities. Therefore, instructing students to focus on creative activities increases their success startle intensities so that the creative activity may be stimulated to action even though focusing also raises the success startle threshold and/or kindling and/or action threshold for success creative activities relative to recreation (or pleasure) r, and self-preservation, s activities and relative to the competing success startles in the normal and unhealthy brains.

It has been found that the success startle and/or kindling and/or activity threshold for recreation (or pleasure) r, and self-preservation, s activities such as play, watching television, or instant gratification for immediate pleasure or play may be lower than for working on Creative Ambitions, CA, and/or Creative Actions or sustained right actions, CA, and/or productive actions or sustained right actions activities that may have time pressure due to a near term deadline. Procrastination, where students defer working on Creative Ambitions, CA, and/or Creative Actions or sustained right actions, CA, and/or productive actions or sustained right actions, but instead pursue recreation (or pleasure) r, and self-preservation, s, activities such as play, watching television, or instant gratification for immediate pleasure or play such that the Creative Ambitions, CA, and/or Creative Actions or sustained right actions, CA, and/or productive actions or sustained right actions may be finished late or just in time, may exemplify this lowered success startle and/or kindling and/or action threshold for recreation (or pleasure) r, and self-preservation, a, activities such as play, watching television, or instant gratification for immediate pleasure or play. Therefore, teaching the students to focus on the Creative Ambitions, CA, and/or Creative Actions or sustained right actions, CA, and/or productive actions or sustained right actions in contrast to recreation (or pleasure) r, and self-preservation, s, thereby increasing the students' success startle for the Creative Ambitions, CA, and/or Creative Actions or sustained right actions, CA, and/or productive actions or sustained right actions may overcome the students' naturally occurring stop reflex due to homeostasis, thereby causing students to engage in the Creative Ambitions, CA, and/or Creative Actions or sustained right actions, CA, and/or productive actions or sustained right actions activities and/or carry them out.

Alternatively, in the step 116 of the method 1, the student is taught that their choice of creative activity over recreation, r, and/or survival, s, may be based on a perceived relative rewards associated with each activity and that there is a natural attraction towards activities with the greatest perceived relative rewards.

In step 116, the student is taught the concept of Perceived Relative Reward. Perceived Relative Reward can be defined as a ratio of perceived pleasure to perceived pain as in equation (1) infra:

$$\text{Perceived Relative Reward} = \frac{\text{Average Perceived Pleasure}}{\text{Average Perceived Pain}} \qquad ( 1 )$$

where:
Perceived Pleasure includes enjoyable activity drives such as love, happiness, altruism, Creative Ambition comfort, Creative Ambition excitement, Creative Ambition wealth, Creative Ambition sex, success, positive legacy and inspiration. Here, activity drives such as Creative Ambition wealth and sex are not drives for recreation, I, or survival, a, wealth and drives for recreation, r, sex for instant gratification. Perceived Pain includes un-enjoyable recreation, r, and/or survival, s, withdrawal drives such as from fear, physical or emotional pain, discomfort, shame, guilt, worry, and regret.

In step 116, the students may be taught to ascribe an intensity for each of the Perceived Pleasures listed supra for a given activity on a scale of 0-10, wherein 0 means no pleasure, a 5 means average pleasure, and 10 means the greatest intensity of pleasure that the students ascribe to the given activity to determine the quantity “Perceived Pleasure.” In like manner, the students may be taught to ascribe an intensity for each of the Perceived Pains listed supra for a given activity on a scale of 0-10, wherein 0 means no pain, a 5 means average pain, and 10 means the greatest intensity of pain that the students ascribe to the given activity to determine the quantity “Perceived Pain.” Each of “Average Perceived Pleasure” and “Average Perceived Pain” may be determined by averaging each of “Perceived Pleasure” and “Perceived Pain” for the given activity, wherein any appropriate method of statistical averaging such as equal weighting or non-equal weighting may be used to determine each of “Average Perceived Pleasure” and “Average Perceived Pain.”

In step 116, the student is taught that a high Perceived Relative Reward (high Perceived Pleasure) promotes action in those activities and a low Perceived Relative Reward (high Perceived Pain) promotes avoidance of actions or sustained right actions in those activities. The student is taught that the probability of action thus increases as Perceived Relative Reward increases. In step 116, the student is taught how to increase or decrease their Perceived Relative Reward. On one hand, increasing their perceptions of love, happiness and the greater good served by fulfilling their Creative Ambition and/or Creative Actions or sustained right actions, can increase a students' Perceived Relative Reward. On the other hand, decreasing their perceptions of pain, fear, shame, guilt, discomfort and regret associated with not fulfilling their Creative Ambitions can decrease a students' Perceived Relative Reward.

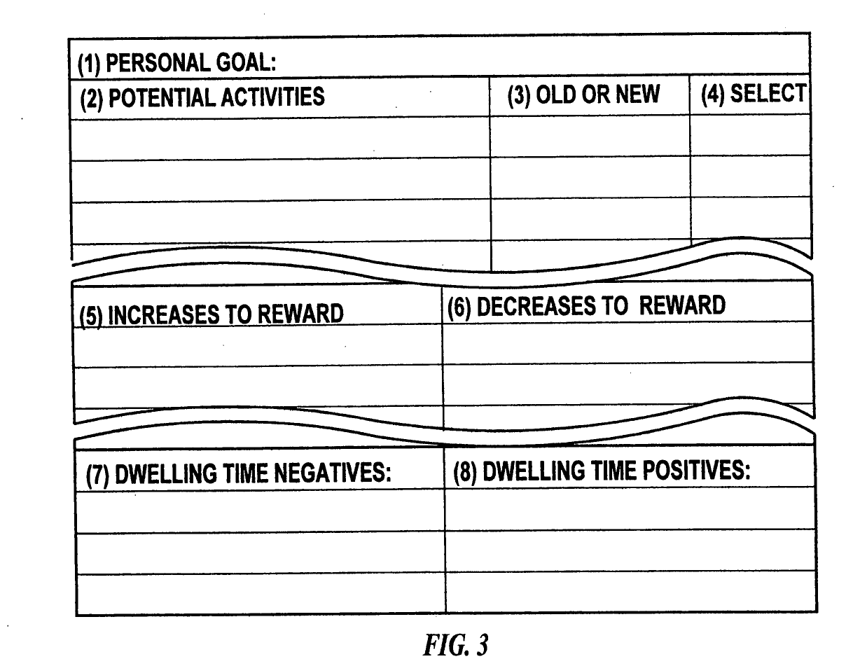

In the step 118 of the method 1, as depicted in FIG. 1H, supra, the students may be instructed to create a crisis of need or relevance to overcome their naturally occurring stop reflex. The students may be taught that time may expire before they have achieved their compelling desire and/or their personal goal. Students may be taught to project or estimate a timeline for achieving their compelling desire and/or their personal goal. Students may be taught to make a plan for completing their compelling desire and/or their personal goal and to determine if the estimated time to the plan exceeds the time they want to wait. Students may be taught to recognize their dissatisfaction with the length of the timeline for completion may be a crisis of need or relevance that may motivate them shift their energy for their plan. FIG. 2, infra, depicts a crisis of need or relevance. In FIG. 2,

FIG. 2 is a pictorial representation illustrating a crisis of need or relevance. In FIG. 2 the likelihood of reaching a goal is plotted versus time. It is immediately apparent that the likelihood of reaching a goal increases with the amount of time spent in activities powering reaching the goal. The time axis is split into the past and the future by the present time. The present is time T0. Without the method of the present invention, the projected slope of the line of likelihood of reaching a goal over time is the result of old habits and routines of dwelling time between new brain and old brain activities remains the same as in past time (left of T0) and the goal is accomplished at time T2. With the method of the present invention, the projected slope of the line of likelihood of reaching a goal over time is the result of new habits and routines of creative energy or dwelling time shifted from old brain activities to new brain activities increases and the goal may be accomplished at time T2, taking less time. In FIG. 2 the energy shift represented by the steeper slope of the line of likelihood of reaching a goal over time that is the result of new habits and routines of creative energy or dwelling time (present to T1) is an increased efficiency in achieving the goal. FIG. 2 may be presented to students as part of the method 1 of the present invention.

The techniques taught to the students to overcome the stop reflex due to homeostasis in order to cause students to engage in the activity and/or carry it out in the steps 112, 114, 116, and/or 118 of the method 1 may be used in any order. Alternatively, the students may be taught to use at least one of the steps 112, 114, 116, and/or 118, or any combinations thereof. In the steps 112, 114, 116, and/or 118 of the method 1, the students may be taught to use the following techniques to overcome the stop reflex in order to cause students to engage in the activity and/or carry it to override all obstacles and barriers: identify their talent-matched desired contribution to others; identify parallel pleasure anchors, i.e., rewards to promote and sustain your pursuit interest; elevate their gravitational energy. Hereinafter, gravitational energy is their creative energy that may unify and focus the students' mental, physical and spiritual energies, i.e., their attention, interest, pleasure, determination and endurance; increase their mental and physical processing speed; and increase their closure rate for achieving or accomplishing their compelling desire and personal goal.

In step 130, students may be instructed to self-monitor themselves whether they have achieved their compelling desire or personal goal, as identified in the step 95, supra.

If, as a result of surveillance and/or self-monitoring and/or self-governance, the students conclude they may not have achieved their compelling desire or personal goal, the students are instructed as in step 140, of the method 1, to reiterate steps 100 to 130. Alternatively, if, as a result of surveillance and/or self-monitoring and/or self-governance, the students conclude they may have may have achieved their compelling desire or personal goal, or if the students decide they no longer want to pursue their compelling desire or personal goal, the students are instructed to proceed to step 145, of the method 1, described infra.

In the step 145 of the method 1, the students may be instructed to reiterate steps 95 to 130 of the method 1, as depicted in FIG. 1A, supra. FIG. 1F depicts another embodiment of the step 115 of the method 1, wherein the students may be instructed to redistribute and rebalance their initial foreground recreation energy, FGEᵣ, as in a success CA•rs redistribution 45 in a direction of the arrow 47. In FIG. 1F, the students may have redistributed their initial foreground recreation energy, FGEᵣ, such that a portion of their initial foreground recreation energy, FGEᵣ may be reallocated as new success final foreground Creative Ambitions and/or Creative Actions or sustained right actions energy FGE_{CA′}, such that their final Creative Ambitions and/or Creative Actions or sustained right actions energy, FGE_{CA′}, includes present success FGE_{CA′} and new succes FGE_{CA′} to accomplish the students' moment-to-moment thoughts or sustained right thinking and behaviors. The students may be instructed that such new success may require management and reallocation of their initial recreation or survival foreground creative energy, FGE_{r,s}, rather than diminishing final present success foreground creative energy, FGE_{CA′}. Here final foreground creative energy, FGE_{r′,s′} is equal to the final foreground creative energy the students allocate to recreation, FGE_{r′} and the final foreground creative energy the students allocate to survival, FGE_{s′}. Therefore, the students may be instructed that one goal of success is to preserve present success.

Alternatively, in the step 145 of the method 1, the students may be instructed to reiterate steps 95 to 130 of the method 1, as depicted in FIG. 1A, supra, such that the students may be instructed to redistribute and rebalance their initial recreation energy, FGEᵣ, as in a success CA•rs redistribution 15 and 16, as in FIGS. 1C and 1D, supra. In this embodiment, the students may have redistributed their initial recreation energy, Eᵣ, such that a portion of their initial recreation energy, Eᵣ may be reallocated as new success final Creative Ambitions and/or Creative Actions or sustained right actions energy E_{CA′}, such that their final Creative Ambitions and/or Creative Actions or sustained right actions energy, E_{CA′}, includes present success E_{CA′} and new succes E_{CA′} to accomplish the students' moment-to-moment thoughts or sustained right thinking and behaviors. The students may be instructed that such new success may require management and reallocation of their initial recreation or survival creative energy, E_{r,s}, rather than diminishing final present success creative energy, E_{CA′}. Here final creative recreation and survival energy, E_{r′,s′}, is equal to the final creative energy the students allocate to recreation, E_{r′} and the final creative energy the students allocate to survival, E_{s′}. Therefore, the students may be instructed that one goal of success is to preserve present success.

The students may be taught that redistributing and rebalancing their dwelling time can reclaim their loss of their boundary-less or free spirit. The student is further taught that success can be achieved by the combination of rebalancing dwelling time, de-emphasizing self-preservation and recreation (or pleasure), reclaiming their carefree creative nature, promoting adventure and change and promoting success-creative activities.

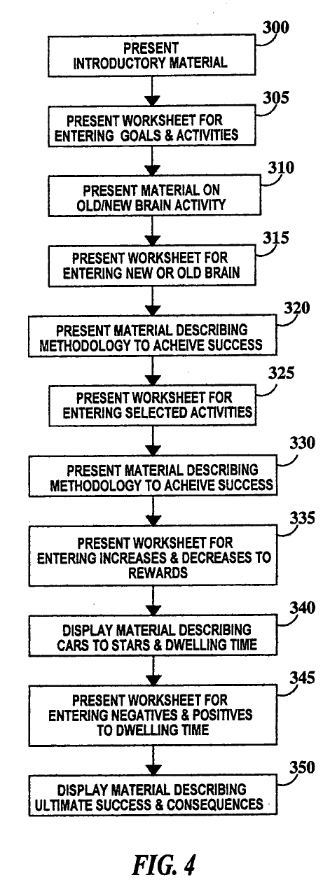

FIG. 3 is a diagram of a worksheet that may be used to practice the present invention. The worksheet in FIG. 10 may be used by either the student to apply what they have learned or as a tool in the teaching of the method of the present invention to the student. The worksheet in FIG. 3 comprises eight Fields that may be filled in by a student of the method of the present invention in sequential order. In Field (1) Personal Goal, the student is instructed to enter their personal goal. In Field (2) Potential Activities, the student is instructed to enter possible or potential activities they believe, if performed diligently, will lead to success in accomplishing the goal. In Field (3) Old or New, the student is instructed to categorize each activity based on whether the activity is a new brain activity or and old brain activity as described supra. In Field (4) Select, the student is instructed to select at least one of the possible or potential activities to actually implement based on the corresponding categorization made in Field (3). In Field (5) Increases to Reward, the student indicates what they can do to increase their-perceived pleasure by implementation of the selected activities as taught supra. This may include inclusion and/or examination of sub-activities within the selected possible or potential activities. In Field (6) Decreases to Reward, the student indicates what to look out for that will increase their perceived pain by implementation of the selected activities as taught supra. The student then told to develop strategies to minimize these increases to perceived pain. In Field (7) Dwelling Time Negatives, the student is instructed to list what self-monitoring and/or self-governance should be done to minimize the potentially destructive dwelling time as taught supra. In Field (8) Dwelling Time Positives, the student is instructed to list what self-monitoring and/or self-governance should be put in place to maximize the potentially constructive dwelling time, as taught supra.

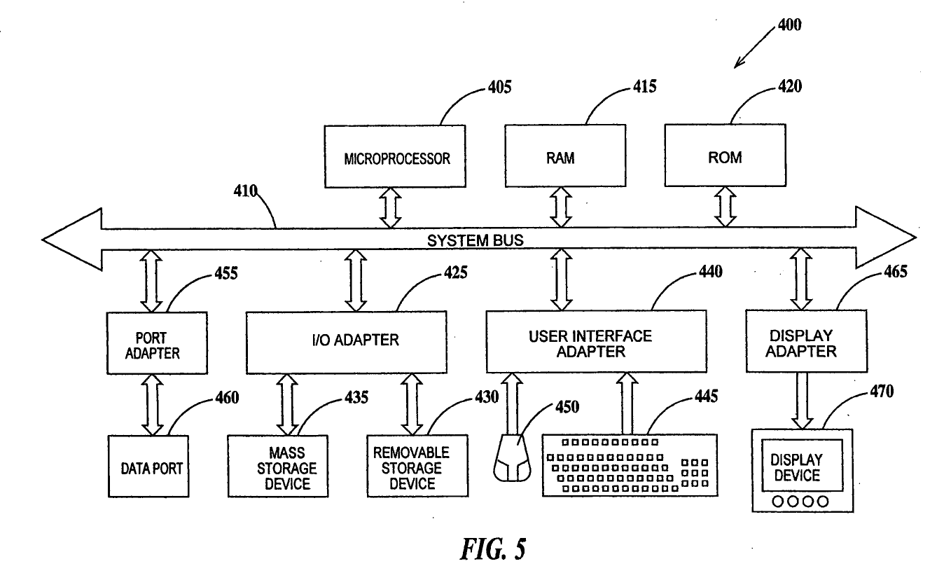

FIG. 4 is an overall flowchart of a method for integrating the teaching success according to the present invention and the worksheet of FIG. 3 into an interactive method of teaching the present invention. For the purposes of describing FIG. 4, the terms “present, to present and presenting” are defined to mean projecting on a wall screen or a television screen using, for example, a slide or foil projector as well as displaying on a computer screen under the direction of a computer program the subject matter being taught. The terms “enter and entering” are defined to mean writing on a paper worksheet or typing through a keyboard (or moving or clicking a pointing device) linked to a computer adapted to display the information entered on a screen.

FIG. 4 depicts a method for presenting the method 1 for teaching success, as depicted in FIG. 1A, supra. In step 300, the introductory material described supra in reference to FIG. 1A, steps 95-100 may be presented to the students. In step 305, a worksheet (for example that illustrated in FIG. 3 and described supra may be presented to the students for the students to enter their personal goal and possible or potential activities to achieve the personal goal as described supra in reference to FIG. 1A, step 95. In step 310, the new brain/old brain material described supra in reference to FIG. 1A, step 100 may be presented to the students. In step 315, the worksheet for the student to enter their determination of which of the possible or potential activities are new brain activities and which are old brain activities as described supra in reference to FIG. 1A, step 100 may be presented to the students. In step 320, the methodology to achieve success material described supra in reference to FIG. 1A, step 115 may be presented to the students. In step 325, the worksheet for the student to select which of the possible or potential activities to implement as described supra in reference to FIG. 1A, step 95 is presented to the students. In step 330, the methodology to achieve success material described supra in reference to FIG. 1A, step 115 may be presented to the students. In step 335, the worksheet for the student to enter increases and decreases to rewards described in FIG. 1E, steps 51, 52, and 54 may be presented to the students. In step 340, the FAST CA•rs MAKE HOLLYWOOD STARS material described supra in reference FIG. 1E, steps 51, 52, and 54 and dwelling time material described supra in reference to FIGS. 1D and 1E, steps 51, 52, and 54 is presented to the students. In step 345, the worksheet for the students to enter negatives and positives to dwelling time is presented to the student. Finally, in step 350, the material describing ultimate success and consequences displayed supra in reference to FIG. 1E, step 54 may be presented to the student. The students now have a plan, constructed according to the present invention, for successfully achieving the personal goal that they may implement.

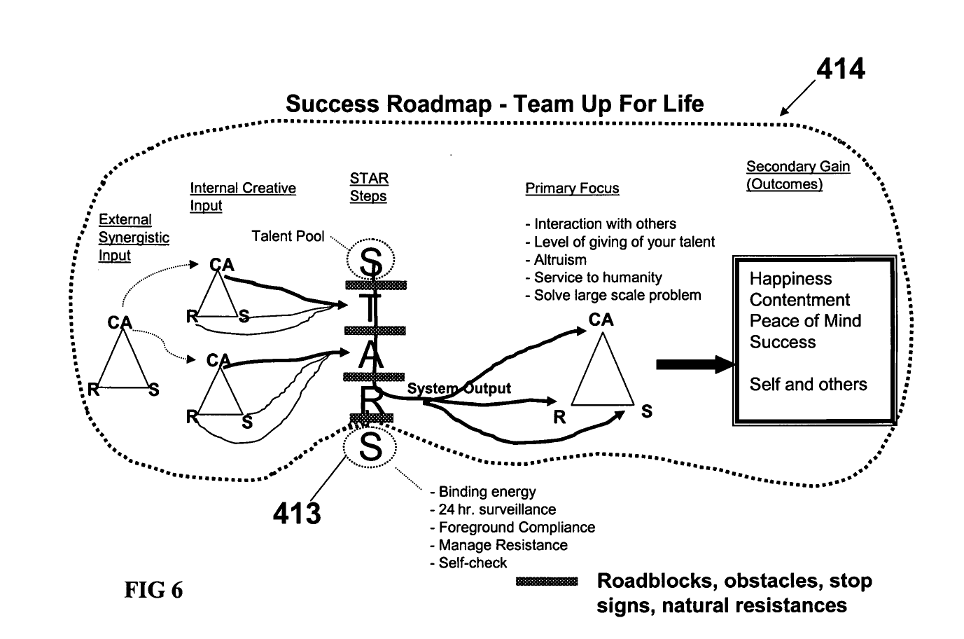

Generally, the method 1 described herein, using the worksheet illustrated in FIG. 3 and described supra, may be practiced with a general-purpose computer and the method may be coded as a set of instructions on removable or hard media for use by the general-purpose computer. FIG. 5 is a schematic block diagram of a general-purpose computer for practicing the present invention. In FIG. 5, computer system 400 has at least one microprocessor or central processing unit (CPU) 405. CPU 405 is interconnected via a system bus 410 to a random access memory (RAM) 415, a read-only memory (ROM) 420, an input/output (I/O) adapter 425 for a connecting a removable data and/or program storage device 430 and a mass data and/or program storage device 435, a user interface adapter 440 for connecting a keyboard 445 and a mouse 450, a port adapter 455 for connecting a data port 460 and a display adapter 465 for connecting a display device 470.

ROM 420 contains the basic operating system for computer system 400. The operating system may alternatively reside in RAM 415 or elsewhere as is known in the art. Examples of removable data and/or program storage device 430 include magnetic media such as floppy drives and tape drives and optical media such as CD ROM drives. Examples of mass data and/or program storage device 435 include hard disk drives and non-volatile memory such as flash memory. In addition to keyboard 445 and mouse 450, other user input devices such as trackballs, writing tablets, pressure pads, microphones, light pens and position-sensing screen displays may be connected to user interface 440. Examples of display devices include cathode-ray tubes (CRT) and liquid crystal displays (LCD).

A computer program with an appropriate application interface may be created by one of skill in the art and stored on the system or a data and/or program storage device to simplify the practicing of this invention. In operation, information for or the computer program created to run the present invention is loaded on the appropriate removable data and/or program storage device 430, fed through data port 460 or typed in using keyboard 445. In a first example, the slides illustrated in the Appendix may be written to a storage media and self-presented by a student. In a second example, the slides illustrated in the Appendix and the worksheet of FIG. 3 may be written to a storage media and self-presented by a student, the worksheet being presented at appropriate intervals during the presentation of the slides of the Appendix and student input accepted for predetermined fields of the worksheet at predetermined points in the presentation of the slides.

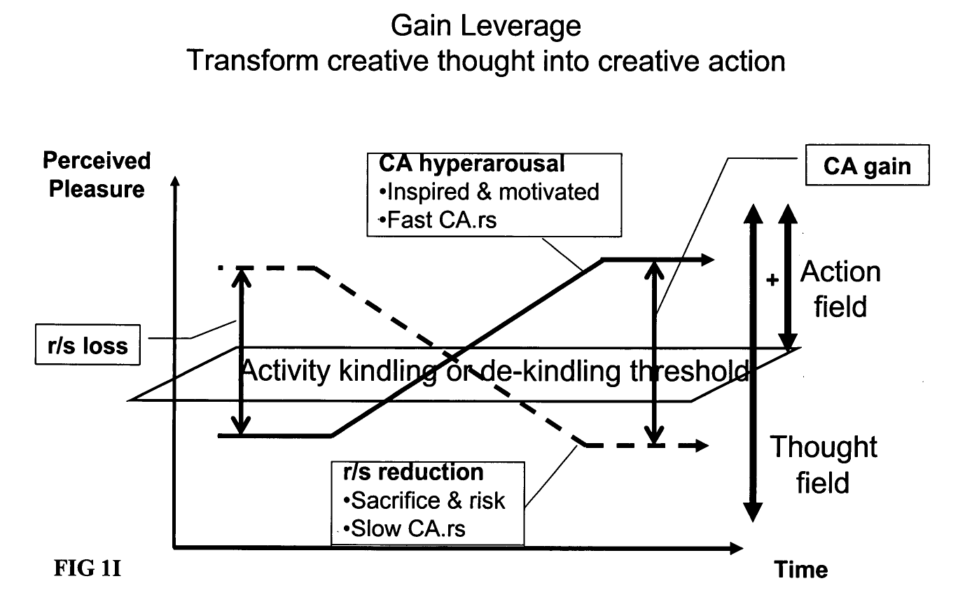

FIG. 6 depicts an embodiment in which the Success Roadmap 414, as in step 115 of the method 1, may be a “Success Roadmap—Team Up For Life” process, comprising the following “STAR” categories: Spirit, Thought, Action, Results, and Surveillance, self-monitoring and or self-governance 413 (for monitoring Creative Ambitions and/or Creative Action or Dwelling Time, DT). Each thought or action may receive input from a “CA•rs” category, wherein the CA•rs categories are Creative Ambitions and/or Creative Actions or sustained right actions, Recreation and Survival. FIG. 6 depicts External Synergistic and Internal Creative Inputs to the CA•rs categories, wherein the inputs may be possible or potential old and new brain activities and the student may be taught to identify the activities as old and new brain activities and to characterize the inputs into new brain Creative Ambitions and/or Creative Actions or sustained right actions by increasing his dwell time for new brain activities. External Synergistic Input may be input from a source “outside of” and “external to” the student that creates an enhanced combined effect. The student may be instructed to find External Synergistic Input from a book, work of art, a person who is a kindred spirit, a person who is a professional colleague, a person who is a loved one, another student, and combinations thereof. The External Synergistic Input may be suggestions and inspirations for Creative Ambitions and/or Creative Actions or sustained right actions for the student when it is the External Synergistic Input to the CA•rs categories. Cooperative interactions or sustained right actions between agencies such as the student and the External Synergistic Input may result in “synergism,” where synergism means a simultaneous action of separate agencies total effect than the sum of their individual effects. Internal Creative Input may be input arising from within the student resulting from instructing the student to be original, expressive, artistic, clever, cool, demiurgic, deviceful, fertile, formative, gifted, hip, ingenious, innovational, innovative, innovatory, inspired, inventive, original, originative, productive, prolific, stimulating, visionary, and imaginative that may be suggestions and inspirations for Creative Ambitions and/or Creative Actions or sustained right actions for the student when the Internal Creative Inputs are input into the CA•rs categories.

The combined inputs from External Synergistic and Internal Creative Inputs may be a talent pool that may be a total talent that results from the allocation of that the student allocates to the STAR Steps as depicted in FIG. 6, when the student is instructed in the Detailed Methodology to Achieve Success. Thus, the present invention provides a method and system for teaching people to achieve success in meeting goals that effect their spiritual, emotional or physical well-being.

The description of the embodiments of the present invention is given above for the understanding of the present invention. It will be understood that the invention is not limited to the particular embodiments described herein, but is capable of various modifications, rearrangements and substitutions as will now become apparent to those skilled in the art without departing from the scope of the invention. Therefore, it is intended that the following claims cover all such modifications and changes as fall within the true spirit and scope of the invention.

[image]

[image]

[image]

[image]

[image]

[image]

[image]

[image]

[image]

[image]

[image]

[image]

[image]

[image]

[image]

[image]

[image]

[image]

1. A method for teaching success to a student, comprising:
a. instructing said student to identify a compelling desire or personal goal of said student;
b. instructing said student to list possible or potential old brain activities that result in SLOW CA•rs and possible or potential new brain activities that result in FAST CA•rs;
c. instructing said student to select and implement at least one of the possible or potential new brain activities associated with the FAST CA•rs;
d. instructing said student to utilize a success roadmap to achieve the FAST CA•rs in order to achieve said compelling desire or personal goal;
e. instructing said student to ask whether said compelling desire or personal goal of said student has been achieved; and
f. instructing said student to repeat steps b to e if the compelling desire or personal goal has not been achieved, or to exit the method.

2. The method of claim 1, wherein the step of utilizing a success roadmap includes utilizing activity kindling or controlled hyper-arousal by said student.

3. The method of claim 1, wherein the step of utilizing a success roadmap includes utilizing self-deprivation.

4. The method of claim 1, wherein the step of utilizing a success roadmap includes self-controlled increase of said student's success-startle threshold or activity kindling threshold.

5. The method of claim 1, wherein the step of utilizing a success roadmap includes creating a crisis of need or relevance for said student.

6. The method of claim 1, further including teaching said student how to self-monitor said set of possible or potential activities in order to reduce time spent dwelling on old brain activities.

7. The method of claim 1, further including:
teaching said student that each activity in said set of activities has an associated perceived relative reward; and
teaching said student how to increase said associated perceived relative reward.

8. The method of claim 7, wherein each perceived relative reward is defined as a ratio of perceived pleasure associated with a given activity to a perceived pain associated with said given activity.

9. The method of claim 8, wherein said perceived pleasure is selected from the group consisting of love, happiness, altruism, Creative Ambition comfort, Creative Ambition excitement, Creative Ambition wealth, Creative Ambition sex, success, positive legacy, inspiration and combinations thereof.

10. The method of claim 8, wherein perceived pain is selected from the group consisting of fear, physical or emotional pain, discomfort, shame, guilt, worry, regret, and combinations thereof.

11. A method for teaching success to a student, comprising:
a. instructing said student to identify a compelling desire or personal goal of said student;
b. recording said compelling desire or personal goal of said student;
c. instructing said student to list possible or potential old brain activities that result in SLOW CA•rs and possible or potential new brain activities that result in FAST CA•rs;
d. instructing said student how to select and implement at least one of the possible or potential new brain activities associated with the FAST CA•rs;
e. instructing said student to how to utilize a success roadmap to achieve the FAST CA•rs in order to achieve said compelling desire or personal goal;
f. instructing said student to ask whether said compelling desire or personal goal of said student has been achieved; and
g. instructing said student to repeat steps b to e if the compelling desire or personal goal has not been achieved, or to exit the method.

12. The method of claim 1, wherein the step of utilizing a success roadmap includes utilizing activity kindling or controlled hyper-arousal by said student.

13. The method of claim 1, wherein the step of utilizing a success roadmap includes utilizing self-deprivation.

14. The method of claim 1, wherein the step of utilizing a success roadmap includes self-controlled increase of said student's success-startle threshold or activity kindling threshold.

15. The method of claim 1, wherein the step of utilizing a success roadmap includes creating a crisis of need or relevance for said student.

16. The method of claim 11, further including:
teaching said student how to self-monitor each activity of said set of possible or potential activities for each activity's dwelling time, wherein each activity's dwelling time is the time spent on thinking about or performing that activity;
instructing said student to formulate actions or sustained right actions for monitoring said dwelling time of each activity of said set of possible or potential activities; and
recording said dwelling time of each activity of said set of possible or potential activities.

17. The method of claim 11, further including
teaching said student each activity of said set of possible or potential activities has a perceived relative reward;
teaching said student how to increase the perceived relative reward and how to decrease perceived relative rewards;
instructing said student to determine for each activity of said set of possible or potential activities, actions or sustained right actions that will increase and activities, actions or sustained right actions that will decrease each activities' perceived relative reward; and
recording said activities, actions or sustained right actions that will increase and activities, actions or sustained right actions that will decrease said perceived relative reward.

18. The method of claim 17, wherein each perceived relative reward is defined as a ration of perceived pleasure associated with a given activity to a perceived pain associated with said given activity.

19. The method of claim 18, wherein said perceived pleasure is selected from the group consisting of love, happiness, altruism, Creative Ambition comfort, Creative Ambition excitement, Creative Ambition wealth, Creative Ambition sex, success, positive legacy, inspiration and combinations thereof.

20. The method of claim 18, wherein perceived pain is selected from the group consisting of fear, physical or emotional pain, discomfort, shame, guilt, worry, regret, and combinations thereof.

21. A program storage device readable by a machine, tangibly embodying a program of instructions executable by said machine to perform method steps for a method for teaching success to a student said method steps comprising:
instructing said student to identify a compelling desire or a personal goal;
instructing said student to identify a set of possible or potential activities to achieve said compelling desire or personal goal;
teaching said student to distinguish each activity of said set of possible or potential activities between new brain activity and an old brain activity, said new brain activity promoting achieving said personal goal and said old brain activity impeding achieving the goal; and
instructing said student to implement at least one activity of said of activities identified as new brain activities in order to achieve said personal goal.

22. The program storage device of claim 21, further including selecting from said set of possible or potential activities at least one activity identified as the old brain activities.

23. The program storage device of claim 21, the method steps further including:
teaching said student to utilize a success roadmap for achieve his compelling desire or personal goal;
teaching said student to use self-governance to test whether his thoughts or sustained right thinking, “T”, “actions or sustained right actions,” “A”, and “results,” “R,” are powered by their creative energy of their “Ideal Self” and/or “Spirited Living or Sustained Spirit Energy.”

24. The program storage device of claim 21, wherein said new brain activity is selected from the group consisting of engaging in creativity, exercising wisdom, engaging in spirituality, exercising faith, exercising love, feeling exhilaration, feeling mental vibrancy, exercising mental agility, feeling eagerness, exercising optimism, altruism, engaging in adventure, engaging in logical reasoning, engaging in risk-taking, exercising delayed gratification, feeling complex emotions and combinations thereof.

25. The program storage device of claim 21, wherein said old brain activity is selected from the group consisting of engaging in survival activity, engaging in self-preservation activity, exercising concern for personal safety, feeling fear, engaging in worry, engaging in flight, exercising flight reflexes, engaging in impulsive responses and combinations thereof.

26. The program storage device of claim 21, the method steps further including teaching said student how to self-monitor or self-govern said set of possible or potential activities in order to reduce time spent dwelling on old brain activities.

27. The program storage device of claim 21, the method steps further including:
teaching said student that each activity in said set of activities has an associated perceived relative reward; and
teaching said student how to increase the associated perceived relative reward.

28. The program storage device of claim 27, wherein each perceived relative reward is defined as a ratio of perceived pleasure associated with a given activity to a perceived pain associated with said given activity.

29. The program storage device of claim 28, wherein said perceived pleasure is selected from the group consisting of love, happiness, altruism, Creative Ambition comfort, Creative Ambition excitement, Creative Ambition wealth, Creative Ambition sex, success, positive legacy, inspiration and combinations thereof.

30. The program storage device of claim 28, wherein perceived pain is selected from the group consisting of fear, physical or emotional pain, discomfort, shame, guilt, worry, regret, and combinations thereof.

31. A program storage device readable by a machine, tangibly embodying a program of instructions executable by said machine to perform method steps for a method for teaching success to a student, said method steps comprising:
instructing said student to identify a personal goal;
recording said personal goal;
teaching said student to identify a set of possible or potential activities to achieve said personal goal;
recording said set of possible or potential activities;
teaching said student how to distinguish each activity of said set of possible or potential activities between new brain activity and an old brain activity, said new brain activity promoting achieving said personal goal and said old brain activity impeding achieving the goal;
instructing said student to determine for each activity of said set of possible or potential activities if each activity is a new brain activity or an old brain activity
recording said determinations for each activity;
instructing said student to implement at least one activity of said of activities identified as new brain activities in order to achieve said personal goal.

32. The program storage device of claim 31, the method steps further including removing from said set of possible or potential activities at least one to all activities identified as old brain activities.

33. The program storage device of claim 31, the method steps further including:
teaching said student that new brain activity is directed to Creative Ambitions or Creative Actions or sustained right actions; and
teaching said student that old brain activities are directed to recreation and self-preservation.

34. The program storage device of claim 31, wherein said new brain activity is selected from the group consisting of engaging in creativity, exercising wisdom, engaging in spirituality, exercising faith, exercising love, feeling exhilaration, feeling mental vibrancy, exercising mental agility, feeling eagerness, exercising optimism, altruism, engaging in adventure, engaging in logical reasoning, engaging in risk-taking, exercising delayed gratification, feeling complex emotions and combinations thereof.

35. The program storage device of claim 31, wherein said old brain activity is selected from the group consisting of engaging in survival activity, engaging in self-preservation activity, exercising concern for personal safety, feeling fear, engaging in worry, engaging in flight, exercising flight reflexes, engaging in impulsive responses and combinations thereof.

36. The program storage device of claim 31, the method steps further including:
teaching said student how to self-monitor each activity of said set of possible or potential activities for each activities dwelling time, wherein each activities dwelling time is the time spent on thinking about or performing that activity;
instructing said student to formulate actions or sustained right actions for monitoring said dwelling time of each activity of said set of possible or potential activities; and
recording said for monitoring said dwelling time of each activity of said set of possible or potential activities.

37. The program storage device of claim 31, the method steps further including
teaching said student each activity of said set of possible or potential activities has a perceived relative reward;
teaching said student in how to increase perceived relative rewards and how to decrease perceived relative rewards;
instructing said student to determine for each activity of said set of possible or potential activities actions or sustained right actions that will increase and actions or sustained right actions that will decrease each activities perceived relative reward; and
recording said actions or sustained right actions that will increase and actions or sustained right actions that will decrease said perceived relative reward.

38. The program storage device of claim 37, wherein each perceived relative reward is defined as a perceived pleasure associated with a given activity pseudo-divided by a perceived pain associated with said given activity.

39. The program storage device of claim 38, wherein said perceived pleasure is selected from the consisting of love, happiness, altruism, Creative Ambition comfort, Creative Ambition excitement, Creative Ambition wealth, Creative Ambition sex, success, positive legacy, inspiration and combinations thereof.

40. The program storage device of claim 38, wherein perceived pain is selected from the group consisting of fear, physical or emotional pain, discomfort, shame, guilt, worry, regret, and combinations thereof.
